(19) United States
(12) Patent Application Publication
(10) Pub. No.: US 2025/0260814 A1
(43) Pub. Date: Aug. 14, 2025

(54) VIDEO ENCODING METHOD, VIDEO DECODING METHOD, APPARATUS, DEVICE AND STORAGE MEDIUM

(71) Applicant: GUANGDONG OPPO MOBILE TELECOMMUNICATIONS CORP., LTD., Dongguan (CN)

(72) Inventor: Hang HUANG, Dongguan (CN)

(21) Appl. No.: 19/193,459

(22) Filed: Apr. 29, 2025

Related U.S. Application Data
(63) Continuation of application No. PCT/CN2022/128693, filed on Oct. 31, 2022.

(51) Int. Cl. H04N 19/117; H04N 19/176; H04N 19/70; H04N 19/80

(52) U.S. Cl. CPC H04N 19/117; H04N 19/176; H04N 19/70; H04N 19/80

(57) ABSTRACT

A video encoding method includes that: when encoding or decoding a current picture, first determining whether the current picture needs to use a TIP frame as an output picture of the current picture, in response to that it is determined that the TIP frame corresponding to the current picture needs to be used as the output picture of the current picture, skipping encoding or decoding first information corresponding to the current picture, where the first information is used to indicate a first interpolation filter, and the first interpolation filter is used to perform interpolation filtering on a reference block of a current block in the current picture.

### CROSS-REFERENCE TO RELATED APPLICATION

This application is a Continuation Application of International Application No. PCT/CN2022/128693 filed on Oct. 31, 2022, which is incorporated herein by reference in its entirety.

### TECHNICAL FIELD

The present application relates to the field of video coding technology, and in particular, to a video encoding method, a video decoding method, an apparatus, a device and a storage medium.

### RELATED ART

Digital video technology can be incorporated into a variety of video apparatuses, such as digital televisions, smartphones, computers, e-readers, or video players. With the development of video technology, the amount of data included in video data is larger, and in order to facilitate transmission of the video data, video apparatuses implement video compression technology to enable to transmit or store the video data more efficiently.

Since there is temporal or spatial redundancy in the video, the redundancy in the video may be eliminate or reduce by prediction, and the compression efficiency may be improved. In the current coding method, bit overhead has been increased, and a problem of coding invalid information is existed, thereby reducing coding performance.

### SUMMARY

Embodiments of the present application provide a video encoding method, a video decoding method, an apparatus, a device and a storage medium.

In a first aspect, the embodiments of the present application provide a video decoding method, which includes:
determining whether to use a temporal interpolated prediction (TIP) frame corresponding to a current picture as an output picture of the current picture; and
in response to that it is determined that the TIP frame is used as the output picture of the current picture, skipping decoding first information, where the first information is used to indicate a first interpolation filter, and the first interpolation filter is used to perform interpolation filtering on a reference block of a current block in the current picture.

In a second aspect, the present application provides a video encoding method, which includes:
determining whether to use a temporal interpolated prediction (TIP) frame corresponding to a current picture as an output picture of the current picture; and
in response to that it is determined that the TIP frame is used as the output picture of the current picture, skipping encoding first information, where the first information is used to indicate a first interpolation filter, and the first interpolation filter is used to perform interpolation filtering on a reference block of a current block in the current picture.

In a third aspect, the present application provides a video decoding apparatus, which is configured to perform the method in the first aspect or its various implementations. In some implementation, the apparatus includes functional units configured to perform the method in the first aspect or its various implementations.

In a fourth aspect, the present application provides a video encoding apparatus, which is configured to perform the method in the second aspect or its various implementations. In some implementation, the apparatus includes functional units configured to perform the method in the second aspect or its various implementations.

In a fifth aspect, a video decoder is provided, and the video decoder includes: a processor and a memory. The memory is configured to store a computer program, and the processor is configured to call the computer program stored in the memory and run the computer program, to perform the method in the first aspect or its various implementations.

In a sixth aspect, a video encoder is provided, and the video encoder includes: a processor and a memory. The memory is configured to store a computer program, and the processor is configured to call the computer program stored in the memory and run the computer program, to perform the method in the second aspect or its various implementations.

In a seventh aspect, a video coding system is provided, and the video coding system includes: a video encoder and a video decoder. The video decoder is configured to perform the method in the first aspect or its various implementations, and the video encoder is configured to perform the method in the second aspect or its various implementations.

In an eighth aspect, a chip is provided, which is configured to implement the method in any one of the above first to second aspects or various implementations thereof. In some implementation, the chip includes a processor configured to call a computer program from a memory and run the computer program, to cause a device equipped with the chip to perform the method in any one of the above first to second aspects or various implementations thereof.

In a ninth aspect, a non-transitory computer-readable storage medium is provided, which is configured to store a computer program. The computer program causes a computer to perform the method in any one of the above first to second aspects or various implementations thereof.

In a tenth aspect, a computer program product is provided, which includes computer program instructions. The computer program instructions cause a computer to perform the method in any one of the above first to second aspects or various implementations thereof.

In an eleventh aspect, a computer program is provided, and the computer program, when executed on a computer, causes the computer to perform the method in any one of the above first to second aspects or various implementations thereof.

In a twelfth aspect, a bitstream is provided, which is generated based on the method of the second aspect. Optionally, the bitstream includes at least one of a first parameter and a second parameter.

### BRIEF DESCRIPTION OF THE DRAWINGS

FIG. 1 is a schematic block diagram of a video coding system involved in the embodiments of the present application.

FIG. 2 is a schematic block diagram of a video encoder involved in the embodiments of the present application.

FIG. 3 is a schematic block diagram of a video decoder involved in the embodiments of the present application.

FIG. 4A is a schematic diagram of unidirectional prediction (uni-prediction).

FIG. 4B is a schematic diagram of bidirectional prediction (bi-prediction).

FIG. 5A is a schematic diagram of spatial prediction.

FIG. 5B is a schematic diagram of temporal prediction.

FIG. 6 is a schematic diagram of an integer sample, ½ samples, and ¼ samples.

FIG. 7 is a schematic diagram of TIP.

FIG. 8 is a schematic flowchart of a video decoding method provided by an embodiment of the present application.

FIG. 9 is a schematic flowchart of a video decoding method provided by another embodiment of the present application.

FIG. 10 is a schematic flowchart of a video encoding method provided by an embodiment of the present application.

FIG. 11 is a schematic flowchart of a video encoding method provided by another embodiment of the present application.

FIG. 12 is a schematic block diagram of a video decoding apparatus provided by the embodiments of the present application.

FIG. 13 is a schematic block diagram of a video encoding apparatus provided by the embodiments of the present application.

FIG. 14 is a schematic block diagram of an electronic device provided by the embodiments of the present application.

FIG. 15 is a schematic block diagram of a video coding system provided by the embodiments of the present application.

### DETAILED DESCRIPTION

The present application may be applied to a field of picture coding, a field of video coding, a field of hardware video coding, a field of dedicated circuit video coding, a field of real-time video coding, or the like. For example, the solution of the present application may be in conjunction with an audio video coding standard (AVS), such as H.264/audio video coding (AVC) standard, H.265/high efficiency video coding (HEVC) standard, and H.266/versatile video coding (VVC) standard. Alternatively, the solution of the present application may be operated in conjunction with other dedicated or industrial standards, the standards include ITU-TH.261, ISO/IECMPEG-1Visual, ITU-TH.262 or ISO/IECMPEG-2Visual, ITU-TH.263, ISO/IECMPEG-4Visual, ITU-TH.264 (also referred to as ISO/IECMPEG-4AVC), containing scalable video coding (SVC) and multi-view video coding (MVC) extensions. It should be understood that, the technology of the present application is not limited to any particular coding standard or technology.

For ease of understanding, a video coding system involved in the embodiments of the present application is first introduced in conjunction with FIG. 1.

FIG. 1 is a schematic block diagram of a video coding system involved in the embodiments of the present application. It should be noted that FIG. 1 is only an example, and the video coding system of the embodiments of the present application includes but is not limited to that shown in FIG. 1. As shown in FIG. 1, the video coding system 100 includes an encoding device 110 and a decoding device 120. The encoding device is configured to encode (which may be understood as compress) video data to generate a bitstream, and transmit the bitstream to the decoding device. The decoding device decodes the bitstream generated by the encoding device to obtain decoded video data.

The encoding device 110 of the embodiments of the present application may be understood as a device with a video encoding function, and the decoding device 120 may be understood as a device with a video decoding function, that is, in the embodiments of the present application, the encoding device 110 and the decoding device 120 contain a wider range of apparatuses, such as contain a smartphone, a desktop computer, a mobile computing apparatus, a notebook (e.g., laptop) computer, a tablet computer, a set-top box, a television, a camera, a display apparatus, a digital media player, a video game console, an in-vehicle computer.

In some embodiments, the encoding device 110 may transmit encoded video data (e.g., a bitstream) to the decoding device 120 via a channel 130. The channel 130 may include one or more media and/or apparatuses which are able to transmit the encoded video data from the encoding device 110 to the decoding device 120.

In an instance, the channel 130 includes one or more communication media that enable the encoding device 110 to transmit the encoded video data directly to the decoding device 120 in real-time. In this instance, the encoding device 110 may modulate the encoded video data according to a communication standard and transmit modulated video data to the decoding device 120. The communication media includes a wireless communication media, e.g., a radio frequency spectrum. Optionally, the communication medium may further include a wired communication media, e.g., one or more physical transmission lines.

In another instance, the channel 130 includes a storage medium, the storage medium may store the video data encoded by the encoding device 110. The storage medium includes a variety of locally accessible data storage media, such as an optical disk, a DVD, a flash memory. In this instance, the decoding device 120 may obtain the encoded video data from the storage medium.

In yet another instance, the channel 130 may include a storage server, which may store the video data encoded by the encoding device 110. In this instance, the decoding device 120 may download the encoded video data stored in the storage server from the storage server. Optionally, the storage server may store the encoded video data and transmit the encoded video data to the decoding device 120, such as a web server (e.g., for a website), a file transfer protocol (FTP) server.

In some embodiments, the encoding device 110 includes a video encoder 112 and an output interface 113. The output interface 113 may include a modulator/demodulator (a modem) and/or a transmitter.

In some embodiments, the encoding device 110 may further includes a video source 111 in addition to the video encoder 112 and the output interface 113.

The video source 111 may include at least one of a video collecting apparatus (e.g., a video camera), a video archive, a video input interface, or a computer graphics system, where the video input interface is used to receive video data from a video content provider, and the computer graphics system is used to generate video data.

The video encoder 112 encodes the video data from the video source 111 to generate a bitstream. The video data may include one or more pictures or sequences of pictures. The bitstream contains encoded information of the picture or the sequence of pictures in the form of a bitstream. The encoded information may include encoded picture data and associated data. The associated data may include a sequence parameter set (which is abbreviated as SPS), a picture parameter set (which is abbreviated as PPS) and other syntax structures. The SPS may contain parameters applied to one or more sequences. The PPS may contain parameters applied to one or more pictures. A syntax structure is a set of one or more syntax elements arranged in a specified order in the bitstream.

The video encoder 112 transmits the encoded video data directly to the decoding device 120 via the output interface 113. The encoded video data may further be stored in a storage medium or a storage server for subsequent reading by the decoding device 120.

In some embodiments, the decoding device 120 includes an input interface 121 and a video decoder 122.

In some embodiments, the decoding device 120 may include a display apparatus 123 in addition to the input interface 121 and the video decoder 122.

Here, the input interface 121 includes a receiver and/or a modem. The input interface 121 may receive the encoded video data via the channel 130.

The video decoder 122 is used to decode the encoded video data to obtain decoded video data, and transmit the decoded video data to the display apparatus 123.

The display apparatus 123 displays the decoded video data. The display apparatus 123 may be integrated with or external to the decoding device 120. The display apparatus 123 may include various display apparatuses, such as a liquid crystal display (LCD), a plasma display, an organic light emitting diode (OLED) display, or other types of display apparatuses.

In addition, FIG. 1 is only an example, and the technical solution of the embodiments of the present application is not limited to FIG. 1. For example, the technology of the present application may also be applied to unilateral video encoding or unilateral video decoding.

The video encoding framework involved in the embodiments of the present application will be introduced below.

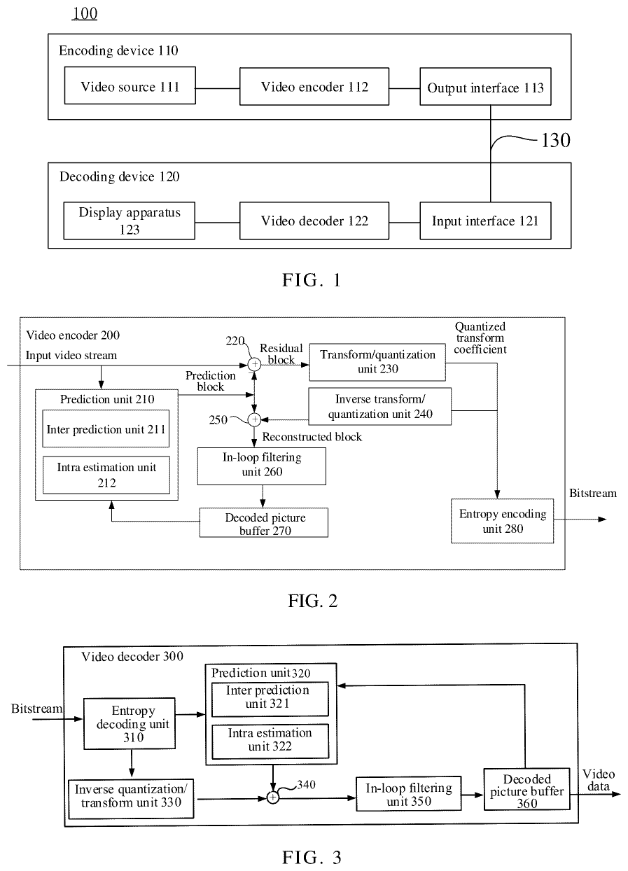

FIG. 2 is a schematic block diagram of a video encoder involved in the embodiments of the present application. It should be understood that the video encoder 200 may be used to perform lossy compression on a picture, or may be used to perform lossless compression on a picture. The lossless compression may be visually lossless compression or mathematically lossless compression.

The video encoder 200 may be applied to picture data in a luma and chroma (YCbCr, YUV) format. For example, a YUV ratio may be 4:2:0, 4:2:2 or 4:4:4, where Y indicates luma, Cb (U) indicates blue chroma, Cr (V) indicates red chroma, U and V indicate chroma for describing color and saturation. For example, in a color format, 4:2:0 means that there are 4 luma components and 2 chroma components (YYYYCbCr) for every 4 samples, 4:2:2 means that there are 4 luma components and 4 chroma components (YYYYCbCrCbCr) forevery 4 samples, and 4:4:4 means full sample display (YYYYCbCrCbCrCbCrCbCr).

For example, the video encoder 200 reads video data, and for each picture in the video data, divides one picture into several coding tree units (CTUs). In some examples, a CTB may be referred to as a “tree block”, “largest coding unit (LCU)” or “coding tree block (CTB)”. Each CTU may be associated with sample blocks of equal size within the picture. Each sample may correspond to one luma (luminance) sample and two chroma (chrominance) samples. Thus, each CTU may be associated with one luma sample block and two chroma sample blocks. The size of a CTU is, for example, 128×128, 64×64, 32×32. A CTU may be further divided into several coding units (CUs) for encoding. A CU may be a rectangular block or a square block. The CU may be further divided into prediction units (PUs) and transform units (TUs), which makes encoding, prediction and transform separation more flexible in processing. In an example, a CTU is divided into CUs in a quadtree manner, and a CU is also divided into TUs and PUs in the quadtree manner. The video encoder and the video decoder may support various PU sizes. Assuming that the size of a specific CU is 2N×2N, the video encoder and the video decoder may support a PU size of 2N×2N or N×N for intra prediction, and support symmetric PUs with 2N×2N, 2N×N, N×2N, N×N or similar sizes for inter prediction. The video encoder and video decoder may further support asymmetric PUs with 2N×nU, 2N×nD, nL×2N, and nR×2N for inter prediction.

In some embodiments, as shown in FIG. 2, the video encoder 200 may include: a prediction unit 210, a residual unit 220, a transform/quantization unit 230, an inverse transform/quantization unit 240, a reconstructed unit 250, an in-loop filtering unit 260, a decoded picture buffer 270 and an entropy encoding unit 280. It should be noted that the video encoder 200 may include more, fewer or different functional components.

Optionally, in the present application, a current block may be referred to as a current coding unit (CU) or a current prediction unit (PU), or the like. A prediction block may also be referred to as a prediction picture block or a picture prediction block, and the reconstructed picture block may also be referred to as a reconstructed block or a picture reconstructed picture block.

In some embodiments, the prediction unit 210 includes an inter prediction unit 211 and an intra estimation unit 212. Since there is a strong correlation between neighboring samples in a picture of a video, the intra prediction method is used in the video coding technology to eliminate spatial redundancy between the neighboring samples. Since there is strong similarity between the neighboring in the video, the inter prediction method is used in the video coding technology to eliminate temporal redundancy between the neighboring samples, thereby improving encoding efficiency.

The inter prediction unit 211 may be used for inter prediction, which may include motion estimation and motion compensation. The inter prediction may refer to picture information of different frames (pictures). In the inter prediction, motion information is used to find a reference block from a reference frame, and according to the reference block, a prediction block generated to eliminate temporal redundancy. Frames used for the inter prediction may include a P frame and/or a B frame, the P frame refers to a forward prediction frame, and the B frame refer to a bi-prediction frame. In the inter prediction, the motion information used to find the reference block from the reference frame, and the prediction block is generated according to the reference block. The motion information includes a reference frame list where the reference frame is located, a reference frame index, and a motion vector. The motion vector may belong to an integer sample or a fractional sample. If the motion vector belongs to the fractional sample, it is necessary to use interpolation filtering in the reference frame to obtain a block of the required fractional sample. Here, the block of the integer sample or fractional sample in the reference frame, which is found according to the motion vector, is called the reference block. The reference block is used as a prediction block directly in some technologies, while a prediction block is generated on the basis of processing the reference block in some technologies. The prediction block being generated on the basis of processing the reference block may also be understood as using the reference block as a prediction block and then processing the prediction block to generate a new prediction block.

The intra estimation unit 212 only refers to information of a same picture to predict sample information of a current coding picture block, to eliminate spatial redundancy. A frame used for intra prediction may be an I frame.

There are several prediction modes for intra prediction. Taking the H series of international digital video coding standards as an example, H.264/AVC standard has 8 angle prediction modes and 1 non-angle prediction mode, and H.265/HEVC standard is expanded to 33 angle prediction modes and 2 non-angle prediction modes. The intra prediction modes used in HEVC include Planar, a DC and 33 angle modes, for a total of 35 prediction modes. The intra modes used by VVC includes Planar, DC, and 65 angle modes, for a total of 67 prediction modes.

It should be noted that, with the addition of angle modes, the intra prediction will be more accurate and more in line with the requirements of the evolution of high-definition and ultra-high-definition digital video.

The residual unit 220 may generate a residual block of a CU based on a sample block of the CU and a prediction block of a PU of the CU. For example, the residual unit 220 may generate a residual block of the CU, so that each sample of the residual block has a value equal to a difference between: a sample of the sample block of the CU and a corresponding sample of the prediction block of the PU of the CU.

The transform/quantization unit 230 may quantize a transform coefficient. The transform/quantization unit 230 may quantize a transform coefficient associated with a TU of a CU based on a quantization parameter (QP) value associated with the CU. The video encoder 200 may adjust a quantization degree of the transform coefficient associated with the CU by adjusting the QP value associated with the CU.

The inverse transform/quantization unit 240 may apply inverse quantization and inverse transform to a quantized transform coefficient, respectively, to reconstruct a residual block from the quantized transform coefficient.

The reconstructed unit 250 may add a sample of the reconstructed residual block to a corresponding sample of one or more prediction blocks generated by the prediction unit 210, to generate a reconstructed picture block associated with the TU. By reconstructing the sample block of each TU of the CU in this method, the video encoder 200 may reconstruct the sample block of the CU.

The in-loop filtering unit 260 is used to process the inverse transformed and inverse quantized samples to compensate for distortion information, so as to provide a better reference for subsequent encoded samples. For example, a deblocking filtering operation may be performed to reduce blocking effect of sample blocks associated with the CU.

In some embodiments, the in-loop filtering unit 260 includes a deblocking filtering unit and a sample adaptive offset/adaptive loop filtering (SAO/ALF) unit. The deblocking filtering unit is used for removing square effect, and the SAO/ALF unit is used for removing ringing effect.

The decoded picture buffer 270 may store the reconstructed sample blocks. The inter prediction unit 211 may use a reference frame containing the reconstructed sample block to perform the inter prediction on a PU of other pictures. In addition, the intra estimation unit 212 may use the reconstructed sample block store in the decoded picture buffer 270 to perform the intra prediction on other PUs of the same picture as the CU.

The entropy coding unit 280 may receive the quantized transform coefficient from the transform/quantization unit 230. The entropy coding unit 280 may perform one or more entropy coding operations on the quantized transform coefficient, to generate entropy-coded data.

FIG. 3 is a schematic block diagram of a video decoder involved in the embodiments of the present application.

As shown in FIG. 3, the video decoder 300 includes an entropy decoding unit 310, a prediction unit 320, an inverse quantization/transform unit 330, a reconstructed unit 340, an in-loop filtering unit 350, and a decoded picture buffer 360. It should be noted that the video decoder 300 may include more, fewer or different functional components.

The video decoder 300 may receive a bitstream. The entropy decoding unit 310 may parse the bitstream to extract syntax elements from the bitstream. As a portion of parsing the bitstream, the entropy decoding unit 310 may parse the entropy-coded syntax elements in the bitstream. The prediction unit 320, the inverse quantization/transform unit 330, the reconstructed unit 340, and the in-loop filtering unit 350 may decode video data according to the syntax elements extracted from the bitstream, so that decoded video data is generated.

In some embodiments, the prediction unit 320 includes an intra estimation unit 322 and an inter prediction unit 321.

The intra estimation unit 322 may perform intra prediction to generate a prediction block of PU. The intra estimation unit 322 may use an intra prediction mode to generate the prediction block of the PU based on sample blocks of spatially neighboring PUs. The intra estimation unit 322 may further determine the intra prediction mode for the PU according to one or more syntax elements parsed from the bitstream.

The inter prediction unit 321 may construct a first reference frame list (list 0) and a second reference frame list (list 1) according to syntax elements parsed from the bitstream. Furthermore, if the PU is encoded using inter prediction, the entropy decoding unit 310 may parse motion information of the PU. The inter prediction unit 321 may determine one or more reference blocks of the PU according to the motion information of the PU. The inter prediction unit 321 may generate a prediction block of the PU based on one or more reference blocks of the PU.

The inverse quantization/transform unit 330 may inverse quantize (i.e., dequantize) a transform coefficient associated with a TU. The inverse quantization/transform unit 330 may use a QP value associated with a CU of the TU to determine a quantization degree.

After inverse quantizing the transform coefficient, the inverse quantization/transform unit 330 may apply one or more inverse transforms to the inverse quantized transform coefficient, to generate a residual block associated with the TU.

The reconstructed unit 340 uses the residual block associated with the TU of the CU and a prediction block of the PU of the CU to reconstruct a sample block of the CU. For example, the reconstructed unit 340 may add a sample of the residual block to a corresponding sample of the prediction block to reconstruct the sample block of the CU, to obtain a reconstructed picture block.

The in-loop filtering unit 350 may perform a deblocking filtering operation to reduce blocking effect of the sample block associated with the CU.

The video decoder 300 may store the reconstructed picture of the CU in the decoded picture buffer 360. The video decoder 300 may use the reconstructed picture stored in the decoded picture buffer 360 as a reference frame for subsequent prediction, or transmit the reconstructed picture to a display apparatus for presentation.

The basic procedure of video coding is as follows that: at the encoding side, a picture is partitioned into blocks, and for a current block, the prediction unit 210 generates a prediction block of the current block using intra prediction or inter prediction. The residual unit 220 may calculate a residual block based on the prediction block and an original block of the current block, that is, a difference between the prediction block and the original block of the current block. The residual block may also be referred to as residual information. Information that is not sensitive to the human eye in the residual block can be removed through processes such as being transformed and quantized by the transform/quantization unit 230, to eliminate visual redundancy. Optionally, the residual block that has not been transformed and quantized by the transform/quantization unit 230 may be referred to as a temporal residual block, and the temporal residual block after being transformed and quantized by the transform/quantization unit 230 may be referred to as a frequency residual block or a frequency domain residual block. After receiving the quantized transform coefficient output by the transform/quantization unit 230, the entropy coding unit 280 may perform entropy coding on the quantized transform coefficient, to output a bitstream. For example, the entropy coding unit 280 may eliminate character redundancy according to a target context model and probability information of a binary bitstream.

At the decoding side, the entropy decoding unit 310 may parse the bitstream to obtain prediction information, a quantization coefficient matrix, etc., of the current block, and the prediction unit 320 uses intra prediction or inter prediction for the current block based on the prediction information, to generate a prediction block of the current block. The inverse quantization/transform unit 330 performs inverse quantization and inverse transform on the quantization coefficient matrix obtained from the bitstream, to obtain a residual block. The reconstructed unit 340 adds the prediction block and the residual block, to obtain a reconstructed block. Reconstructed blocks constitute a reconstructed picture. The in-loop filtering unit 350 performs in-loop filtering on the reconstructed picture based on a picture or on a block, to obtain a decoded picture. The encoding side also needs to perform operations similar to those of the decoding side to obtain the decoded picture. The decoded picture may also be referred to as a reconstructed picture, the reconstructed picture may be used as a reference frame of the inter prediction for subsequent picture.

It should be noted that the block partition information, as well as the mode information or parameter information for prediction, transform, quantization, entropy encoding, in-loop filtering, etc., determined by the encoding side are carried in the bitstream if necessary. The decoding side determines the same block divided information, mode information or parameter information for prediction, transform, quantization, entropy coding, in-loop filtering, etc., as that of the encoding side by parsing the bitstream and performing analysis according to existing information, thereby ensuring that the decoded picture obtained by the encoding side is the same as the decoded picture obtained by the decoding side.

The above is the basic procedure of the video encoder and video decoder under the block-based hybrid coding framework. With the evolution of technology, some modules or steps of the framework or processes may be optimized. The present application is applicable to the basic procedure of the video encoder and video decoder under the block-based hybrid encoding framework, but is not limited to the framework and procedure.

In some embodiments, the current block may be a current coding unit (CU) or a current prediction unit (PU), etc. Due to a need for parallel processing, the pictures may be partition into slices, and the slices in the same picture may be processed in parallel, that is, there is no data dependency between them. “Frame” is a commonly used term, which may be generally understood to mean that one frame is one picture. In the application, the frame may also be replaced by a picture or a slice, etc.

The embodiments of the present application mainly relate to an inter prediction.

The inter prediction uses a correlation between video frames to remove temporal redundancy information between video frames. At present, basic principle of a block-based inter coding mode used in mainstream video coding standards is that a reference block with the smallest difference from the current block is found from neighboring reference reconstructed frames via motion estimation, and its reconstructed value is used as a prediction block of the current block. The displacement from the reference block to the current block is called a motion vector, and the process of using the reconstructed value as the prediction value is called motion compensation.

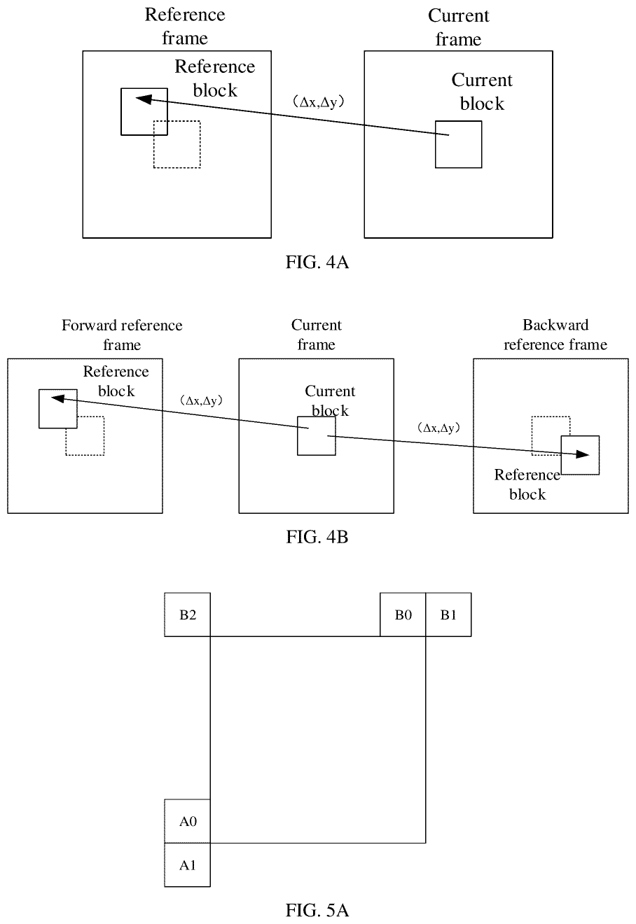

The inter prediction uses motion information to indicate “motion”. The basic motion information includes information of the reference frame (or referred to as reference picture) and information of the motion vector (MV). The inter prediction includes uni-prediction and bi-prediction. As shown in FIG. 4A, the uni-prediction only finds one reference block with the same size as the current block. As shown in FIG. 4B, the bi-prediction uses two reference blocks with the same size as the current block, and the sample value of each point in the prediction block is a weighted average of corresponding positions of the two reference blocks. In the commonly used bi-prediction, two reference blocks are used to predict the current block. A forward reference block and a backward reference block may be used as the two reference blocks. Optionally, it is also allowed that the 2 reference blocks are both forward reference blocks or both backward reference blocks. Forward means that the time corresponding to the reference frame is before the current picture, and backward means that the time corresponding to the reference frame is after the current picture. Alternatively, forward indicates that the position of the reference frame in the video is before the current picture, and backward indicates that the position of the reference frame in the video is after the current picture. Alternatively, forward indicates that a picture order count (POC) of the reference frame is smaller than a POC of the current picture, and backward indicates that the POC of the reference frame is greater than the POC of the current picture. In order to use bi-prediction, it is naturally necessary to find two reference blocks, in this case, two sets of information of reference frames and information of motion vector are needed. Each set of these information may be understood as uni-directional motion information, and bi-directional motion information is formed by combining the two sets together. In exemplary implementation, the uni-directional motion information and bi-directional motion information may use the same data structure, except that the two sets of the information of the reference frame and the information of the motion vector of the bi-directional motion information are both valid, while one set of the information of the reference frame and the information of the motion vector of the uni-directional motion information is invalid.

In some embodiments, two reference frame lists are supported, denoted as RPL0 and RPL1, where RPL is an abbreviation of reference picture list. In some embodiments, P slice may only use RPL0, and B slice may use RPL0 and RPL1. For a slice, each reference frame list contains several reference frames, and the video encoder and video decoder find a reference frame via a reference frame index. In some embodiments, the motion information is indicated by a reference frame index and a motion vector. For the bi-directional motion information, the reference frame index refIdxL0 corresponding to reference frame list 0, the motion vector mvL0 corresponding to reference frame list 0, the reference frame index refIdxL1 corresponding to reference frame list 1 and the motion vector mvL1 corresponding to reference frame list 1 are used. Here, the reference frame index corresponding to the reference frame list 0 and the reference frame index corresponding to the reference frame list 1 may be understood as the information of the reference frame. In some embodiments, two flags are used to indicate whether to use the motion information corresponding to reference frame list 0 and whether to use the motion information corresponding to reference frame list 1, which are respectively denoted as predFlagL0 and predFlagL1. It may also be understood that predFlagL0 and predFlagL1 indicate whether the uni-directional motion information is “valid or not”. Although the data structure of the motion information is not explicitly mentioned, the motion information is indicated by using the reference frame index, the motion vector and the flag of “valid or not” corresponding to each reference frame list. In some standard texts, the motion information does not appear, but a motion vector is used. It may also be considered that the reference frame index and the flag of whether to use the corresponding motion information are attached to the motion vector. In the present application, “motion information” is still used for the convenience of description, but it should be understood that it may also be described as “motion vector”.

The motion information used by the current block may be stored. The subsequently coded (encoded or decoded) blocks of the current picture may use the motion information of previously coded blocks according to the neighboring position relationship, e.g., the neighboring blocks. This utilizes the correlation in the spatial domain, so the coded motion information is called motion information in the spatial domain. The motion information used by each block of the current picture may be stored. The subsequently coded frames may use the motion information of the previously coded frames according to the reference relationship. This utilizes the correlation in the temporal, so the motion information of the coded frame is called motion information in the temporal. The method for storing the motion information used by each block of the current picture usually uses a matrix with a fixed size, such as a 4×4 matrix, as a minimum unit, and each minimum unit stores a set of motion information separately. In this way, for each block encoded or decoded, the smallest units corresponding to its position may store motion information of this block. As thus, when using the motion information in the spatial domain or the motion information in the temporal, the motion information corresponding to the position may be directly found according to the position. If traditional uni-prediction is used on a 16× 16 block, all 4× 4 minimum units corresponding to this block store the motion information of the uni-prediction. If bi-prediction is used on a block, all minimum units corresponding to the block will determine the motion information stored in each minimum unit according to the mode of the bi-prediction, the first motion information, the second motion information and the position of each minimum unit. One method is that if all 4×4 samples corresponding to one minimum unit come from the first motion information, the minimum unit stores the first motion information; if all 4×4 samples corresponding to one minimum unit come from the second motion information, the minimum unit stores the second motion information. If the 4×4 samples corresponding to one minimum unit partly come from the first motion information and partly come from the second motion information, the minimum unit optionally selects one of the motion information for storage; optionally, if the two motion information point to different reference frame lists, they will be combined into bidirectional motion information for storage, otherwise only the second motion information will be stored.

In nature, there is a certain continuity in the motion of objects, so the motion of objects between two neighboring pictures may not be in a unit of integer sample, but may be ½ samples, ¼ samples, etc. In this case, if the integer sample is still used for searching, the problem of inaccurate matching will occur, resulting in a large residual between a final prediction value and an actual value, which affects the encoding performance. Therefore, fractional motion estimation is often used in video standards in recent years, that is, the row and column directions of the reference frame are interpolated first, and searching is performed on the interpolated picture. In HEVC, ¼ samples is used for the motion estimation, and in VVC, the accuracy with 1/16 samples is used for the motion estimation.

In a natural picture, a moving object may cover multiple coding blocks, which may have similar motion information. By using the motion information of neighboring blocks, MVs of the neighboring blocks may be directly used for the current block (no longer need to encode the MVs, merge technology), or the MVs of the neighboring block may be used as predicted MVs of the current block (only the difference between the original MV and the predicted MV (MVD) needs to be encoded, AMVP technology), which may greatly reduce the number of bits required for coding and improve coding efficiency. In the same case, due to the continuity of object motion, there is also a strong correlation between motion vectors in neighboring frames in the temporal. Therefore, as with the predictive encoding of picture samples, the motion vector of the current block may be predicted according to the motion vectors of previously encoded spatial neighboring blocks or temporal neighboring blocks.

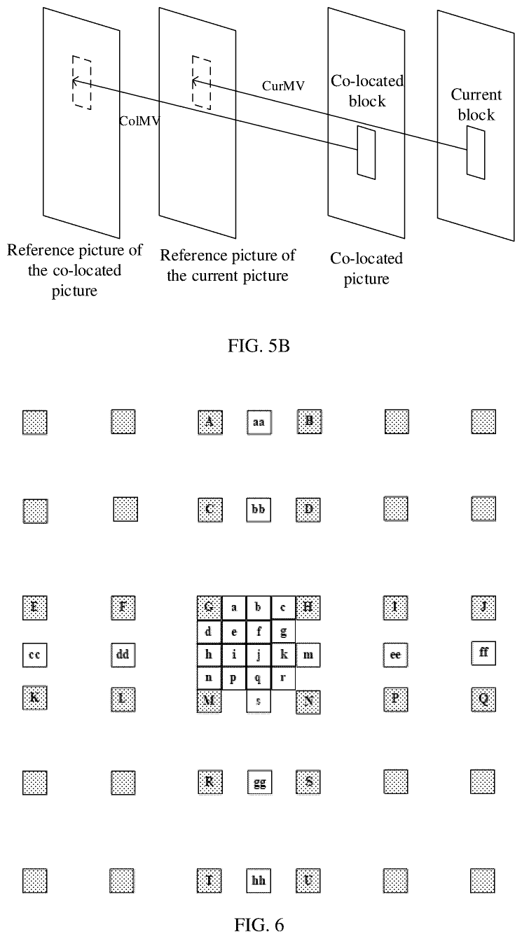

The spatial domain MV prediction technology is to use the MV of the encoding block adjacent to the current block in the spatial domain as the predicted MV of the current block. As shown in FIG. 5A, spatial neighboring blocks generally include an upper left (B1) block, an upper (B0) block, an upper right (B2) block, a left (A0) block, and a lower left (A1) block.

As shown in FIG. 5B, temporal MV prediction typically predicts an MV using a motion vector of a block in the same position as the current block to be encoded in neighboring reconstructed frames.

Merge mode may be regarded as an encoding mode, which directly uses the spatial neighboring MV or the temporal neighboring MV as a final MV of the current block without motion estimation (i.e., there is no MVD). The encoding side and decoding side will construct a merge candidate list (the candidate list contains motion information of neighboring blocks, such as an MV, a reference frame list, a reference frame index) in the same method. The encoding side selects the best candidate MV via RDO and transmits its index in the merge List to the decoding side. The decoding side may obtain the MV by decoding the candidate index and constructing the merge List using the same method as the encoding side.

Skip mode is a special Merge mode, in which the transform and quantization of the prediction residual are skipped. The encoding side only needs to encode an index of the MV in the candidate list, and does not need to encode the quantized residual. At the decoding side, only the corresponding motion information needs to be decoded, and the prediction value is obtained via motion compensation, which is used as the final reconstructed value. In this mode, the number of encoding bits may be greatly reduced.

In order to improve the accuracy of inter prediction, flexible and diverse motion compensation technologies are typically used, including high-precision motion compensation. In actual scenarios, since the distance of object movement is not necessarily an integer multiple of samples, in order to more accurately represent the displacement of the moving object between pictures, the accuracy of motion estimation needs to be improved to a sub-sample level. In this case, the motion compensation is called sub-sample accuracy motion compensation. FIG. 6 is a schematic diagram of integer samples, ½ samples and ¼ samples. In this case, an interpolation filter may be used at the position of a non-integer sample to obtain the predicted sample. In the video standard AV2, the fractional sample accuracy of the motion vector may be accurate to 1/16 samples, and interpolation filters as shown in Table 1 is designed.

TABLE 1

| Interpolation filter | type |
|---|---|
| 0 | EIGHTTAP_REGULAR |
| 1 | EIGHTTAP_SMOOTH |
| 2 | MULTITAP_SHARP |
| 3 | BILINEAR |
| 4 | SWITCHABLE |

EIGHTTAP_REGULAR may be understood as a regular filter, EIGHTTAP_SMOOTH may be understood as a smoothing filter, MULTITAP_SHARP may be understood as a sharpening filter, BILINEAR may be understood as a bilinear filter, and SWITCHABLE may be understood as a switchable filter.

One of the filters may be selected for each encoding block according to encoding cost. The encoder will set a flag of whether the filter is switchable (is_filter_switchable) at a frame level. If the flag is parsed to be 1, it indicates that different filters are used for the current picture. In a case where each piece of unit block information is subsequently decoded, an interpolation filter sequence number used for the current block is continuously decoded. If the flag is parsed to 0, it indicates that the same filter is used for the whole picture, and a filter sequence number used for the current picture is further parsed.

Exemplarily, a relevant syntax table is shown in Table 2.

TABLE 2

| | Type |
|---|---|
| read_interpolation_filter( ) { | |
| is_filter_switchable | f(1) |
| if ( is_filter_switchable == 1 ) { | |
| interpolation_filter = SWITCHABLE | |
| } else { | |
| interpolation_filter | f(2) |
| } | |
| } | |

As shown in Table 2, in a case that the flag is_filter_switchable is parsed to be 1, and interpolation_filter=SWITCHABLE, it is indicates that the filter corresponding to the current picture is a switchable filter, that is, different filters are used for units (e.g., decoding units or encoding units) in the current picture. In a case where block information of each unit is subsequently decoded, the interpolation filter sequence number used for the unit block is further decoded.

Exemplarily, the interpolation filter sequence number used for the unit block is parsed from the syntax shown in Table 3 below.

TABLE 3

| | Type |
|---|---|
| inter_block_mode_info( ) { | |
| . . . | |
| if ( interpolation_filter == SWITCHABLE ) { | |
| for ( dir = 0; dir < ( enable_dual_filter ? 2 : 1 ); dir++ ) { | |
| if ( needs_interp_filter( ) ) { | |
| interp_filter[ dir ] | S( ) |
| } else { | |
| interp_filter[ dir ] = EIGHTTAP | |
| } | |
| } | |
| if ( !enable_dual_filter ) | |
| interp_filter[ 1 ] = interp_filter[ 0 ] | |
| } else { | |
| for ( dir = 0; dir < 2; dir++ ) | |
| interp_filter[ dir ] = interpolation_filter | |
| } | |

In Table 3, interp_filter [dir] indicates the interpolation filter used for the current block.

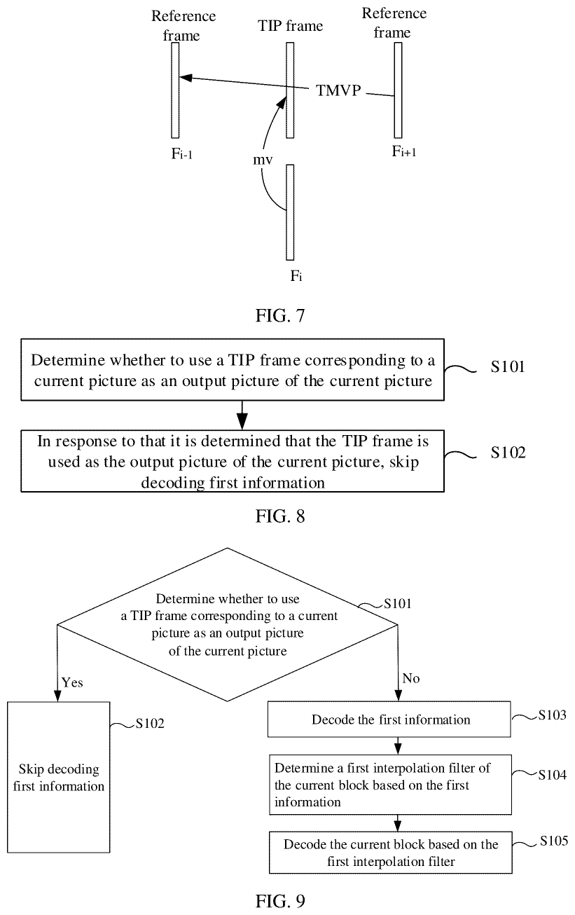

Temporal interpolated prediction (TIP) belongs to an inter coding technology. As shown in FIG. 7, the TIP technology uses a forward reference frame Fi−1 and a backward reference frame Fi+1 and an existing motion vector list to generate an intermediate reference frame by interpolation, which is called a TIP frame. The TIP frame is generally highly correlated with the current picture Fi, and thus may be used as an additional reference frame of the current picture. Under certain conditions, it may even be directly output as the current frame to be encoded.

When generating an interpolated frame, an initial set of motion vector lists is first created. The motion vector list mainly reuses a motion vector list of TMVP and uses a simple motion projection method to make corresponding corrections. Then, according to the motion vector in the motion vector list, the reference block is found in the corresponding reference frame and motion compensation is performed on the reference block.

In the TIP technology, there is a syntax unit tip_frame_mode at the frame level for indicating a temporal interpolated prediction mode used by the current picture.

Exemplarily, the meaning corresponding to each temporal interpolated prediction mode is shown in Table 4.

TABLE 4

| tip_frame_mode | Syntax | meaning |
|---|---|---|
| 0 | TIP_FRAME_DISABLED | Disable TIP mode |
| 1 | TIP_FRAME_AS_REF | TIP frame is used |
| | | as an additional |
| | | reference frame, |
| | | and the current |
| | | picture is |
| | | normally encoded. |
| 2 | TIP_FRAME_AS_OUTPUT | TIP frame is used |
| | | as an output picture |
| | | without encoding |
| | | the current picture |
| | | anymore |

In the existing schemes of AVM, there is a certain logical redundancy between the coding manner of the temporal interpolated prediction mode and the coding manner of the interpolation filter, which increases bit overhead and has a problem of encoding and decoding invalid information, thereby reducing encoding and decoding performance.

In order to solve the above technical problems, when decoding the current picture, the decoding side of the present application first determines whether the current picture needs to use a TIP frame as an output picture of the current picture. In response to that it is determined that the TIP frame corresponding to the current picture needs to be used as the output picture of the current picture, decoding first information corresponding to the current picture is skipped, where the first information is used to indicate a first interpolation filter, and the first interpolation filter is used to perform interpolation filtering on a reference block of a current block in the current picture. That is to say, in the present application, if it is determined that the TIP frame corresponding to the current picture is used as the output picture of the current picture, it means that other traditional decoding steps is skipped for the current pictures, interpolation filtering is not needed to perform on the reference block of the current block by using the first interpolation filter, and then decoding the first information is skipped, so as to avoid decoding invalid information, and thus improving decoding performance.

In a first clause, a video decoding method is provided, which includes:
determining whether to use a temporal interpolated prediction (TIP) frame corresponding to a current picture as an output picture of the current picture; and
in response to that it is determined that the TIP frame is used as the output picture of the current picture, skipping decoding first information, where the first information is used to indicate a first interpolation filter, and the first interpolation filter is used to perform interpolation filtering on a reference block of a current block in the current picture.

In a second clause, according to the first clause, where determining whether to use the temporal interpolated prediction (TIP) frame corresponding to the current picture as the output picture of the current picture includes:
decoding second information corresponding to the current picture from a bitstream, where the second information is used to indicate that the current picture is not encoded using a first TIP mode, the first TIP mode is a mode in which the TIP frame is used as the output picture of the current picture; and
determining that the TIP frame is not used as the output picture of the current picture based on the second information.

In a third clause, according to the first clause, where determining whether to use the temporal interpolated prediction (TIP) frame corresponding to the current picture as the output picture of the current picture includes:
decoding third information from a bitstream, where the third information is used to determine whether the current picture is decoded using a TIP manner; and
determining whether to use the TIP frame as the output picture of the current picture based on the third information.

In a fourth clause, according to the third clause, where determining whether to use the TIP frame as the output picture of the current picture based on the third information includes:
in response to that it is determined that the current picture is decoded using the TIP manner based on the third information, determining a TIP mode corresponding to the current picture; and
determining whether to use the TIP frame as the output picture of the current picture based on the TIP mode corresponding to the current picture.

In a fifth clause, according to the fourth clause, where determining whether to use the TIP frame as the output picture of the current picture based on the TIP mode corresponding to the current picture includes:
in response to that the TIP mode corresponding to the current picture is a first TIP mode, determining that the TIP frame is used as the output picture of the current picture, where the first TIP mode is a mode in which the TIP frame is used as the output picture of the current picture.

In a sixth clause, according to the fourth clause, the method further includes:
in response to that the TIP mode corresponding to the current picture is a first TIP mode, creating the TIP frame; and
using the TIP frame as the output picture of the current picture and outputting the TIP frame.

In a seventh clause, according to the fourth clause, where determining whether to use the TIP frame as the output picture of the current picture based on the TIP mode corresponding to the current picture includes:
in response to that the TIP mode corresponding to the current picture is not a first TIP mode, determining that the TIP frame is not used as the output picture of the current picture, where the first TIP mode is a mode in which the TIP frame is used as the output picture of the current picture.

In an eighth clause, according to the seventh clause, the method further includes:
in response to that the TIP mode corresponding to the current picture is a second TIP mode, creating the TIP frame, where the second TIP mode is a mode in which the TIP frame is
used as an additional reference frame of the current picture; and using the TIP frame as the additional reference frame of the current picture, and determining a reconstructed picture of the current picture.

In a ninth clause, according to the fourth clause, where in a case where the third information includes a TIP enable flag, the method further includes:
determining whether the current picture is decoded using the TIP manner based on the TIP enable flag.

In a tenth clause, according to the third clause, where determining whether to use the TIP frame as the output picture of the current picture based on the third information includes:
in response to that it is determined that the current picture is not decoded using the TIP manner based on the third information, determining that the TIP frame is not used as the output picture of the current picture.

In an eleventh clause, according to the third clause, the method further includes:
in response to that the third information includes a first instruction, determining that the current picture is not decoded using the TIP manner, where the first instruction is used to indicate that TIP is disabled for the current picture.

In a twelfth clause, according to any one of the first to eleventh clauses, the method further includes:
in response to that it is determined that the TIP frame is not used as the output picture of the current picture, decoding the first information;
determining a first interpolation filter of the current block based on the first information; and
decoding the current block based on the first interpolation filter.

In a thirteenth clause, according to the twelfth clause, where in a case where the first information includes a first flag, determining the first interpolation filter of the current block based on the first information includes:

in response to that the first information includes the first flag, determining the first interpolation filter of the current block based on the first flag, where the first flag is used to indicate whether an interpolation filter corresponding to the current picture is switchable.

In a fourteenth clause, according to the thirteenth clause, where determining the first interpolation filter of the current block based on the first flag includes:
in response to that the first flag indicates that the interpolation filter corresponding to the current picture is not switchable, determining the interpolation filter corresponding to the current picture as the first interpolation filter of the current block.

In a fifteenth clause, according to the thirteenth clause, where determining the first interpolation filter of the current block based on the first flag includes:
in response to that the first flag indicates that the interpolation filter corresponding to the current picture is switchable, decoding a bitstream to obtain a first interpolation filter index; and
determining the first interpolation filter based on the first interpolation filter index.

In a sixteenth clause, according to the first clause, the method further includes:
in response to that it is determined that the current picture is decoded using a TIP manner, determining a second interpolation filter corresponding to the current picture, where the second interpolation filter is used to determine the TIP frame.

In a seventeenth clause, according to the sixteenth clause, where determining the second interpolation filter corresponding to the current picture includes:
decoding a bitstream to obtain a second flag, where the second flag is used to indicate a second interpolation filter index corresponding to the current picture; and
determining the second interpolation filter based on the second flag.

In an eighteenth clause, according to the first clause, the method further includes:
in response to that it is determined that the current picture is decoded using a TIP manner, determining a third interpolation filter corresponding to a picture block in the TIP frame, where the third interpolation filter is used to determine the picture block in the TIP frame.

In a nineteenth clause, according to the eighteenth clause, where determining the third interpolation filter corresponding to the picture block in the TIP frame includes:
decoding a bitstream to obtain a third flag, where the third flag is used to indicate a third interpolation filter index corresponding to the picture block; and
determining the third interpolation filter corresponding to the picture block based on the third flag.

In a twentieth clause, according to any one of the sixteenth to nineteenth clauses, the method further includes:
in response to that it is determined that the current picture is decoded using the TIP manner, decoding a bitstream to obtain a fourth flag, where the fourth flag is used to indicate whether an interpolation filter corresponding to the TIP frame is switchable; and
in response to that the fourth flag indicates that the interpolation filter corresponding to the TIP frame is not switchable, determining a second interpolation filter corresponding to the current picture, where the second interpolation filter is used to determine the TIP frame.

In a twenty-first clause, according to the twentieth clause, the method further includes:
in response to that the fourth flag indicates that the interpolation filter corresponding to the TIP frame is switchable, determining a third interpolation filter corresponding to a picture block in the TIP frame, where the third interpolation filter is used to determine the picture block in the TIP frame.

In a twenty-second clause, a video encoding method is provided, which includes:
determining whether to use a temporal interpolated prediction (TIP) frame corresponding to a current picture as an output picture of the current picture; and
in response to that it is determined that the TIP frame is used as the output picture of the current picture, skipping encoding first information, where the first information is used to indicate a first interpolation filter, and the first interpolation filter is used to perform interpolation filtering on a reference block of a current block in the current picture.

In a twenty-third clause, according to the twenty-second clause, where determining whether to use the temporal interpolated prediction (TIP) frame corresponding to the current picture as the output picture of the current picture includes:
in response to that it is determined that the current picture is not encoded using a TIP manner, determining that the TIP frame is not used as the output picture of the current picture.

In a twenty-fourth clause, according to the twenty-second clause, where determining whether to use the temporal interpolated prediction (TIP) frame corresponding to the current picture as the output picture of the current picture includes:
in response to that it is determined that the current picture is encoded using a TIP manner, determining a TIP mode corresponding to the current picture; and
determining whether to use the TIP frame as the output picture of the current picture based on the TIP mode corresponding to the current picture.

In a twenty-fifth clause, according to the twenty-fourth clause, where determining the TIP mode corresponding to the current picture includes:
creating the TIP frame;
   determining a first cost when encoding the current picture, in a case where the TIP frame is used as an additional reference frame of the current picture;
   determining a second cost when the TIP frame is used as the output picture of the current picture; and
   determining the TIP mode corresponding to the current picture based on the first cost and the second cost.

In a twenty-sixth clause, according to the twenty-fifth clause, where determining the TIP mode corresponding to the current picture based on the first cost and the second cost includes:
in response to that the first cost is greater than the second cost, determining that the TIP mode corresponding to the current picture is a first TIP mode, where the first TIP mode is a mode in which the TIP frame is used as the output picture of the current picture.

In a twenty-seventh clause, according to the twenty-fifth clause, where determining the TIP mode corresponding to the current picture based on the first cost and the second cost includes:
in response to that the first cost is less than the second cost, determining that the TIP mode corresponding to the current picture is a second TIP mode, where the second TIP mode is a mode in which the TIP frame is used as an additional reference frame of the current picture.

In a twenty-eighth clause, according to the twenty-fourth clause, where determining whether to use the TIP frame as the output picture of the current picture based on the TIP mode corresponding to the current picture includes:
in response to that the TIP mode corresponding to the current picture is a first TIP mode, determining that the TIP frame is used as the output picture of the current picture, where the first TIP mode is a mode in which the TIP frame is used as the output picture of the current picture.

In a twenty-ninth clause, according to the twenty-fourth clause, where determining whether to use the TIP frame as the output picture of the current picture based on the TIP mode corresponding to the current picture includes:
in response to that the TIP mode corresponding to the current picture is not a first TIP mode, determining that the TIP frame is not used as the output picture of the current picture, where the first TIP mode is a mode in which the TIP frame is used as the output picture of the current picture.

In a thirtieth clause, according to the twenty-fourth clause, the method further includes:
encoding the TIP mode corresponding to the current picture into a bitstream.

In a thirty-first clause, according to the twenty-second clause, where determining whether to use the temporal interpolated prediction (TIP) frame corresponding to the current picture as the output picture of the current picture includes:
in response to that it is determined that the current picture is not encoded using a first TIP mode, determining that the TIP frame is not used as the output picture of the current picture, where the first TIP mode is a mode in which the TIP frame is used as the output picture of the current picture.

In a thirty-second clause, according to the thirty-first clause, the method further includes:
encoding second information into a bitstream, where the second information is used to indicate that a TIP mode corresponding to the current picture is not the first TIP mode.

In a thirty-third clause, according to any one of the twenty-second to thirty-second clauses, the method further includes:
encoding third information into a bitstream, where the third information is used to indicate whether the current picture is encoded using a TIP manner.

In a thirty-fourth clause, according to the thirty-third clause, where the third information includes a TIP enable flag, and the TIP enable flag indicates whether the current picture is encoded using the TIP manner.

In a thirty-fifth clause, according to the thirty-third clause, where in response to that the current picture is not encoded using the TIP manner, the third information includes a first instruction, where the first instruction is used to indicate that TIP is disabled for the current picture.

In a thirty-sixth clause, according to any one of the twenty-second to thirty-second clauses, the method further includes:
in response to that it is determined that the TIP frame is not used as the output picture of the current picture, determining the first interpolation filter corresponding to the current block; and
encoding the current block based on the first interpolation filter, where the first interpolation filter is used to determine a reference block in a reference frame for the current block in the current picture.

In a thirty-seventh clause, according to the thirty-sixth clause, where determining the first interpolation filter corresponding to the current block includes:
determining a first flag, where the first flag is used to indicate whether an interpolation filter corresponding to the current picture is switchable; and
determining the first interpolation filter for the current block based on the first flag.

In a thirty-eighth clause, according to the thirty-seventh clause, where determining the first interpolation filter for the current block based on the first flag includes:
in response to that the first flag indicates that the interpolation filter corresponding to the current picture is not switchable, determining the interpolation filter corresponding to the current picture as the first interpolation filter of the current block.

In a thirty-ninth clause, according to the thirty-seventh clause, where determining the first interpolation filter of the current block based on the first flag includes:
in response to that the first flag indicates that the interpolation filter corresponding to the current picture is switchable, determining the first interpolation filter of the current block from multiple preset interpolation filters.

In a fortieth clause, according to the thirty-sixth clause, the method further includes:
determining the first information; and
   encoding the first information into a bitstream, where the first information is used to indicate the first interpolation filter.

In a forty-first clause, according to the fortieth clause, where in response to that a first flag indicates that an interpolation filter corresponding to the current picture is not switchable, the first information includes the first flag.

In a forty-second clause, according to the fortieth clause, where in response to that a first flag indicates that an interpolation filter corresponding to the current picture is switchable, the first information includes the first flag and a first interpolation filter index.

In a forty-third clause, according to the twenty-second clause, the method further includes:
in response to that it is determined that the current picture is encoded using a TIP manner, determining a second interpolation filter corresponding to the current picture, where the second interpolation filter is used to determine the TIP frame.

In a forty-fourth clause, according to the forty-third clause, the method further includes:
encoding a second flag into a bitstream, where the second flag is used to indicate a second interpolation filter index corresponding to the current picture.

In a forty-fifth clause, according to the twenty-second clause, the method further includes:
in response to that it is determined that the current picture is encoded using a TIP manner, determining a third interpolation filter corresponding to a picture block in the TIP frame, where the third interpolation filter is used to determine the picture block in the TIP frame.

In a forty-sixth clause, according to the forty-fifth clause, the method further includes:
encoding a third flag into a bitstream, where the third flag is used to indicate a third interpolation filter index corresponding to the picture block.

In a forty-seventh clause, according to the forty-third to forty-sixth clauses, the method further includes:
determining a fourth flag, where the fourth flag is used to indicate whether an interpolation filter corresponding to the TIP frame is switchable; and
in response to that the fourth flag indicates that the interpolation filter corresponding to the TIP frame is not switchable, determining a second interpolation filter corresponding to the current picture, where the second interpolation filter is used to determine the TIP frame.

In a forty-eighth clause, according to the forty-seventh clause, the method further includes:
in response to that the fourth flag indicates that the interpolation filter corresponding to the TIP frame is switchable, determining a third interpolation filter corresponding to a picture block in the TIP frame, where the third interpolation filter is used to determine the picture block in the TIP frame.

In a forty-ninth clause, according to the forty-seventh clause, the method further includes:
encoding the fourth flag into a bitstream.

The video encoding and decoding method involved in the embodiments of the present application will be introduced below in conjunction with exemplary embodiments.

First, taking the decoding side as an example, the video decoding method provided in the embodiments of the present application will be introduced.

FIG. 8 is a schematic flowchart of a video decoding method provided by an embodiment of the present application. The video decoding method of the embodiments of the present application may be implemented by the video decoding device shown in FIG. 1 or FIG. 3.

As shown in FIG. 8, the video decoding method of the embodiments of the present application includes following content.

S101, whether to use a TIP frame corresponding to a current picture as an output picture of the current picture is determined.

It can be seen from the video decoding method that, in a case of decoding the current picture, a reconstructed block of each decoded block in the current picture is obtained by decoding, and these reconstructed blocks make up a reconstructed picture of the current picture. The process of decoding each decoding block in the current picture is basically the same. Taking a current block as an example, in a case of decoding the current block, a bitstream is decoded to obtain a quantization coefficient of the current block, inverse quantization is performed on the quantization coefficient to obtain a transform coefficient, and inverse transform is performed on the transform coefficient to obtain a residual value of the current block. Then, an intra prediction method or inter prediction method is used to determine a prediction value of the current block, and the prediction value of the current block is added to the residual value to obtain a reconstructed value of the current block.

In the embodiments of the present application, the current block may be understood as a picture block currently being decoded in the current picture. In some embodiments, the current block is also referred to as a current decoding block, a current picture block to be decoded, or the like.

The embodiments of the present application mainly relate to the inter prediction method, that is, the inter prediction method is used to determine the prediction value of the current block.

In some embodiments, in order to improve the accuracy of inter prediction, high accuracy motion compensation is used, that is, the inter prediction method is used to determine a reference block of the current block in a reference frame of the current block, perform interpolation filtering on the reference block of the current block, and based on the reference block after interpolation filtering, determine a prediction value or prediction block of the current block, to improve the prediction accuracy of the current block.

In some embodiments, in a case of decoding the current picture, the decoding side adopts the TIP technology, that is, a forward picture and a backward picture of the current picture are interpolated to obtain an intermediate interpolated frame. In the embodiments of the present application, the intermediate interpolated frame is denoted as a TIP frame, and the current picture is decoded based on the TIP frame.

Several possible cases for the embodiments of the present application will be described below.

Case 1: in the TIP technology, in some TIP modes, e.g., TIP mode 1 shown in Table 4, the current picture is decoded normally by using the TIP frame as an additional reference frame of the current picture. That is, if TIP mode 1 is used for the current picture, the decoding side first determines a reference frame list corresponding to the current picture, where the reference frame list includes N reference frames.

Exemplarily, it is assumed that the reference frame list corresponding to the current picture is as shown in Table 5.

TABLE 5

| index | Reference Frame |
|---|---|
| 0 | Reference frame 0 |
| 1 | Reference frame 1 |
| . . . | . . . |
| N-1 | Reference frame N-1 |

It should be noted that the number of reference frames and types of reference frames included in the reference frame list corresponding to the current picture may be preset or determined based on actual requirements, which is not limited in the embodiments of the present application.

In this case, the decoding side takes the TIP frame as an additional reference frame of the current picture. Where the current picture includes N+1 reference frames. Optionally, the TIP frame may be placed before the N reference frames shown in Table 5, or may be placed after the N reference frames.

Exemplarily, a reference frame list with added TIP frame is shown in Table 6.

TABLE 6

| index | Reference Frame |
|---|---|
| 0 | Reference frame 0 |
| 1 | Reference frame 1 |
| . . . | . . . |
| N-1 | Reference frame N-1 |
| N | TIP frame |

Table 6 shows that the TIP frame is placed at the last position in the reference frame list shown in Table 5, so that a new reference frame list is formed.

Exemplarily, a reference frame list with added a TIP frame is shown in Table 7.

TABLE 7

| index | Reference Frame |
|---|---|
| 0 | TIP frame |
| 1 | Reference frame 0 |
| 2 | Reference frame 1 |
| . . . | . . . |
| N | Reference frame N-1 |

Table 7 shows that the TIP frame is placed at the first position in the reference frame list shown in Table 5, so that a new reference frame list is formed.

Based on the above method, after the new reference frame list is formed, the decoding side decodes the current picture based on the N+1 reference frames.

In some embodiments, in a case of encoding the current picture, the encoding side determines, for the current block in the current picture, a reference block corresponding to the current block in the N+1 reference frames, and determines a motion vector of the current block based on a position of the reference block in the reference frame and a position of the current block in the current picture. The motion vector may be understood as a prediction value, and the motion vector is encoded to obtain the bitstream. In this case, in the embodiment, the encoding side further indicates in the bitstream that the TIP technology is used for the current picture and TIP mode 1 in the TIP technology is used, for example, encoding (writing) the an index of TIP mode 1 into the bitstream. In this way, in a case where the decoding side determines that the TIP technology is used for the current pictures and TIP mode 1 in the TIP technology is used by decoding the bitstream, the decoding side determines the TIP frame corresponding to the current picture, and takes the TIP frame as an additional reference frame of the current picture to decode the current picture. In some embodiments, if high accuracy motion compensation is used for the current picture, a first interpolation filter is used to perform interpolation filtering on the reference block of the current block.

In Case 1, it can be seen from the above that if the TIP technology is used for the current picture and TIP mode 1 in the TIP technology is used, that is, the TIP frame is used as an additional reference frame of the current picture for normal decoding the current picture, and in a case where sub-sample motion compensation is used for the current picture, it is necessary to use the first interpolation filter to perform interpolation filtering on the reference block of the current block.

Case 2: in the TIP technology, in some TIP modes, e.g., TIP mode 2 shown in Table 4, the TIP frame is used as the output picture of the current picture, and normal encoding of the current picture is skipped. That is, if TIP mode 2 is used for the current picture, the encoding side determines the TIP frame corresponding to the current picture, and directly stores the TIP frame in the decoding cache as the output picture of the current picture, that is, the TIP frame is directly taken as the reconstructed picture of the current picture. In this case, the encoding side indicates the TIP mode 2 to the decoding side, so that the decoding side skips decoding the current picture, for example, there is no need to determine the prediction value and residual value of each decoding block in the current picture, and perform inverse quantization and inverse transform on the residual value.

Correspondingly, in a case where the decoding side decodes the bitstream and determines that TIP mode 2 is used for the current picture, the decoding side constructs the TIP frame corresponding to the current picture, directly outputs the TIP frame as the output picture of the current picture, and skips decoding the current picture, that is, a step of determining the reconstructed picture of the current picture is skipped.

In Case 2, if the TIP technology is used for the current picture and the TIP mode 2 in the TIP technology is used, since the TIP frame is directly used as the output picture of the current picture, other decoding steps are skipped, and the step of determining the reference block of each decoding block in the current picture is also skipped, it can be determined that the decoding side does not need to use the first interpolation filter to perform interpolation filtering on the reference block of the current block.

Case 3: if the TIP technology is not used for the current picture, and sub-sample motion compensation is used for the current picture, the decoding side needs to determine the first interpolation filter for the current block and use the first interpolation filter to perform interpolation filtering on the reference block of the current block.

In Case 3, if the TIP technology is not used for the current picture and the sub-sample motion compensation is used for the current picture, the reference block of the current block is determined, the first interpolation filter for the current block is determined, and the first interpolation filter is used to perform interpolation filtering on the reference block of the current block.

According to Case 1 to Case 3, it can be seen that determining whether to decode first information corresponding to the current picture (the first information is used to indicate the first interpolation filter) by the decoding side is related to whether to use the TIP frame corresponding to the current picture as the output picture of the current picture. Therefore, in the embodiments of the present application, before determining whether to decode the first information corresponding to the current picture, the decoding side first determines whether to use the TIP frame corresponding to the current picture as the output picture of the current picture.

In the embodiments of the present application, implementations of determining whether to use the TIP frame corresponding to the current picture as the output picture of the current picture include, but are not limited to the following implementations.

Implementation 1: S101 includes following steps S101-A1 and S101-A2:
S101-A1, decoding second information corresponding to the current picture from a bitstream, where the second information is used to indicate that the current picture is not encoded using a first TIP mode, the first TIP mode is a mode in which the TIP frame is used as the output picture of the current picture; and
S101-A2, determining that the TIP frame is not used as the output picture of the current picture based on the second information.

The first TIP mode of the embodiments of the present application may be understood as TIP mode 2 shown in the Table 4, that is, the TIP frame corresponding to the current picture is used as the output picture of the current picture.

In Implementation 1, in a case of encoding the current picture, the encoding side attempts various technologies and different encoding modes under the different technologies, and finally selects an encoding mode with the lowest cost to encode the current picture. If the encoding side determines that the current picture is not encoded using the first TIP mode, for example, the current picture is not encoded using the TIP technology, or the current picture is encoded using the TIP technology but is encoded using a non-first TIP mode in the TIP technology, for instance, in a case of encoding using TIP mode 1, the encoding side indicates that the current picture is not encoded using the first TIP mode to the decoding side. Exemplarily, the encoding side encodes (writes) the second information in the bitstream, where the second information is used to indicate that the current picture is not encoded using the first TIP mode.

Correspondingly, the decoding side decodes the bitstream to obtain the second information, and determines that the current picture is not encoded using the first TIP mode via the second information, and then based on the second information, determines that the TIP frame is not used as the output picture of the current picture in the current picture.

The specific form of the second information does not limited in the embodiments of the present application.

In some embodiments, the second information includes a flag A. If the encoding side determines that the current picture is not encoded using the first TIP mode, the flag A is set to true, e.g., set to 1. In this way, the decoding side may determine whether the current picture is encoded using the first TIP mode by decoding the flag A. If it is determined that the current picture is not encoded using the first TIP mode, for example, the flag A is equal to 1 (flag A=1), it is determined that the TIP frame is not used as the output picture of the current picture in the current picture.

In some embodiments, the second information includes an instruction, and the encoding side indicates that the current picture is not encoded using the first TIP mode via the instruction.

Exemplarily, the instruction included in the second information is that: tip_frame_mode!=TIP_FRAME_AS_OUTPUT. TIP_FRAME_AS_OUTPUT corresponds to the first TIP mode (i.e., TIP mode 2), as shown in Table 4, it indicates that the TIP frame is used as the output picture and there is no need to encode the current picture anymore.

In Implementation 1, the encoding side directly encodes the second information into the bitstream, and directly (explicitly) indicates that the current picture is not encoded using the first TIP mode via the second information. In this way, the decoding side may directly determine that the TIP frame is not used as the output picture of the current picture in the current picture via the second information, without having to make other reasoning judgments, thereby reducing the decoding complexity of the decoding side and improving the decoding performance.

Implementation 2: S101 includes following steps S101-B1 and S101-B2:
S101-B1, decoding third information from a bitstream, where the third information is used to determine whether the current picture is decoded using a TIP manner; and
S101-B2, determining whether to use the TIP frame as the output picture of the current picture based on the third information.

In Implementation 2, the encoding side does not directly indicate that the encoding side does not use the first TIP mode to encode the current picture, that is, the encoding side does not directly indicate whether to use the TIP frame corresponding to the current picture as the output picture of the current picture. In this case, the decoding side needs to use other information to determine whether the TIP frame is used as the output picture of the current picture in the current picture.

In some implementation, the encoding side encodes third information into the bitstream, and the third information is used to determine whether the current picture is decoded using the TIP manner. The decoding side determines, based on the third information, whether to use the TIP frame of the current picture as the output picture of the current picture when decoding the current picture.

The specific content and form of the third information are not limited in the embodiments of the present application.

In some embodiments, the third information includes a TIP enable flag, e.g., enable_tip, where the TIP enable flag is used to indicate whether the current picture is encoded using the TIP technology. In this way, the decoding side may determine whether the current picture is decoded using the TIP manner based on the TIP enable flag.

In an example, in response to that the encoding side determines that the current picture is encoded using the TIP manner, the TIP enable flag is set to true, e.g., set to 1. In this way, in a case where the decoding side determines that the TIP enable flag is true by decoding the bitstream, it is determined that the current picture is decoded using the TIP manner.

In another example, in response to that the encoding side determines that the current picture is not encoded using the TIP manner, the TIP enable flag is set to false, e.g., set to 0. In this way, in a case where the decoding side determines that the TIP enable flag is false by decoding the bitstream, it is determined that the current picture is not decoded using the TIP manner.

In some embodiments, the third information includes a first instruction, where the first instruction is used to indicate that TIP is disabled for the current picture. That is, in a case where it is determined that the current picture is not encoded using the TIP manner, the encoding side encodes the first instruction into the bitstream, and indicates that TIP is disabled for the current picture via the first instruction. In this way, the decoding side decodes the bitstream to obtain the first instruction, and determines, according to the first instruction, that the current picture is not decoded using the TIP manner.

The specific form of the first instruction is not limited in the embodiments of the present application.

In an example, the first instruction is tip_frame_mode=TIP_FRAME_DISABLED, it can be seen from Table 4, TIP_FRAME_DISABLED means disabling the TIP manner.

The foregoing are only examples of several manifestations (forms) of the third information. The manifestations and content included in the third information of the embodiments of the present application include, but are not limited to the foregoing examples.

After the decoding side decodes the bitstream and obtains the third information, the steps S101-B2 are performed to determine whether to use the TIP frame as the output picture of the current picture based on the third information. In the embodiments of the present application, the implementations of S101-B2 include at least the following examples.

In Example 1, S101-B2 includes the following steps:
S101-B2-11, in response to that it is determined that the current picture is decoded using the TIP manner based on the third information, determining a TIP mode corresponding to the current picture; and
S101-B2-12, determining whether to use the TIP frame as the output picture of the current picture based on the TIP mode corresponding to the current picture.

In the embodiments of the present application, if the decoding side determines that the current picture is decoded using the TIP manner based on the third information, for example, the third information includes a TIP enable flag, the decoding side decodes that the TIP enable flag is true, and then determines that the current picture is decoded using the TIP manner. It can be seen from Case 1 and Case 2 that, if the current picture is encoded using TIP mode 1, the current picture is decoded normally by using the TIP frame as an additional reference frame of the current picture. If sub-sample motion compensation is used for the current picture, the first interpolation filter is needed to perform interpolation filtering on the reference block of the current block. If the current picture is encoded using TIP mode 2, since the TIP frame is directly used as the output picture of the current picture, the decoding process of the current picture is skipped, and the step of decoding the reference blocks of each decoding block in the current picture is also skipped, it can be determined that the decoding side does not need to use the first interpolation filter to perform interpolation filtering on the reference block of the current block.

Based on this, in a case where the decoding side determines that the current picture is decoded using the TIP manner based on the third information, it further needs to determine the TIP mode corresponding to the current picture, and then based on the TIP mode corresponding to the current picture, determine whether to use the TIP frame as the output picture of the current picture.

In an example, if the TIP mode corresponding to the current picture is the first TIP mode (i.e., TIP mode 2 shown in Table 4), it is determined that the TIP frame is used as the output picture of the current picture, where the first TIP mode is a mode in which the TIP frame is used as the output picture of the current picture.

In the embodiment, if the TIP mode corresponding to the current picture is the first TIP mode, that is, it is determined that the current picture is decoded using the first TIP mode, a TIP frame corresponding to the current picture is created, the TIP frame is used as the output picture of the current picture and is output, and any other traditional decoding steps are skipped.

Creating the TIP frame corresponding to the current picture will be introduced below.

The TIP frame corresponding to the current picture may be understood as an intermediate frame inserted between a forward reference frame and a backward reference frame of the current picture, and the intermediate frame is used to replace the current picture.

The method of inserting the intermediate frame between two frames is not limited in the embodiments of the present application.

In some embodiments, the creating process of the TIP frame includes three steps.

Step 1, a rough motion vector field of the TIP frame is obtained by modifying a projection of a temporal motion vector prediction (TMVP).

Exemplarily, first, the existing TMVP process is modified to support storing two motion vectors of blocks encoded using a compound mode. Further, a generation order of the TMVP is modified to bias to the closest reference frame. This is done because the closer reference frame normally has higher motion correlation with the current picture.

The modified TMVP field will be projected to the two closest reference frames (i.e., the forward reference frame and the backward reference frame) to form the rough motion vector field of the TIP frame.

Step 2, the rough motion vector field from step 1 is refined by filling holes and applying smoothing.

First, the motion vector field is refined. The rough motion vector field generated in step 1 may be too rough to obtain good quality when generating interpolated frames. In the embodiments of the present application, refinement processing is performed on the rough motion vector field, for example, hole filling and smoothing is performed on the motion vector field, which help in improving the quality of the final interpolated frame.

In an example, hole filling is performed on the rough motion vector field. In some implementation, after the motion vector is projected, some blocks may not have any relevant projected motion vector information, or may only have partial motion information related thereto. In this case, the block without any projected motion vector information or with only partial projected motion vector information is called a hole. Due to cover or not cover, the hole may appear, or may correspond to source blocks that are not associated with any motion vector in the reference coordinate system (e.g., in a case where the block is internal coded). To generate better interpolated frames, the hole may be filled with available projected motion vectors from neighboring blocks since they have higher correlation.

In another example, projected motion vector filtering is performed. In some implementation, the projected motion vector field may contain unnecessary discontinuities, which may cause artifacts and reduce the quality of the interpolated frame. A simple average filtering smoothing process is used to smooth the motion vector field. A motion vector of a block in a field may be smoothed using an average of motion vectors of the block itself and an average of motion vectors of its left/right/upper/lower adjacent blocks.

Step 3, a TIP frame is generated using the refined motion vector field from step 2.

Based on the motion vector field refined in step 2, motion compensation is used to interpolate the two reference frames and the corresponding motion vectors in the field, to obtain the TIP frame. Optionally, when generating the final prediction, equal weights are used when combining the two reference frames.

In the embodiments of the present application, if it is determines that the TIP mode corresponding to the current picture is the first TIP mode, the decoding side, based on the method of Step 1 to Step 3, creates the TIP frame corresponding to the current picture, uses the TIP frame as the output picture of the current picture and outputs it.

In some embodiments, if the decoding side determines that the TIP mode corresponding to the current picture is not the first TIP mode, it may be determined that the TIP frame is not used as the output picture of the current picture in the current picture. For example, the decoding side decodes the bitstream and obtains that the TIP enable flag is true, it is determined that the current picture is encoded using the TIP mode. Further, the decoding side decodes the bitstream and obtains the TIP mode corresponding to the current picture. If the TIP mode corresponding to the current picture is not the first TIP mode (i.e., TIP mode 2), it may be determined that the TIP frame is not used as the output picture of the current picture.

In some embodiments, if the decoding side determines that the TIP mode corresponding to the current picture is not the first TIP mode but the second TIP mode, the second TIP mode is a mode in which the TIP frame is used as an additional reference frame of the current picture, that is, the second TIP mode is TIP mode 1 shown in Table 4. In this case, the decoding side creates the TIP frame corresponding to the current picture based on the Step 1 to Step 3, performs conventional decoding on the current picture using the TIP frame as the additional reference frame of the current picture, to determine a reconstructed picture of the current picture.

Exemplarily, the reference frame list corresponding to the current picture is assumed as shown in Table 7, which is obtained by using the TIP frame as the additional reference frame of the current picture. For the current block in the current picture, The decoding side determines the reference frame corresponding to the current block from the reference frame list shown in Table 7, for example, the bitstream is decoded to obtain an reference frame index corresponding to the current block, and the reference frame corresponding to the current block is determined from the reference frame list shown in Table 7 based on the reference frame index. Then, the bitstream is decoded to obtain the motion vector corresponding to the current block. Based on the position and motion vector of the current block, a reference block corresponding to the current block is determined in the reference frame corresponding to the current block, and then the prediction value of the current block is determined based on the reference block, for example, a reconstructed value of the reference block is determined as the prediction value of the current block. After that, the bitstream is decoded to determine a residual value of the current block, and finally the prediction value of the current block is added to the residual value to obtain the reconstructed value of the current block. For each decoded block in the current picture, the reconstructed value of each decoded block is determined in the same manner as the current block, thereby obtaining a reconstructed picture of the current picture.

As can be seen from above that, in Implementation 2, the decoding side determines whether to use the TIP frame as the output picture of the current picture based on the third information. For example, if based on the third information, it is determined that the current picture is decoded using the TIP manner, the TIP mode corresponding to the current picture is determined. In response to that the TIP mode corresponding to the current picture is the first TIP mode, it is determined that the TIP frame corresponding to the current picture is used as the output picture of the current picture. In response to that the TIP mode corresponding to the current picture is not the first TIP mode, it is determined that the TIP frame corresponding to the current picture is not used as the output picture of the current picture. For another example, if based on the third information, it is determined that the current picture is decoded using the TIP manner, it is determined that the TIP frame corresponding to the current picture is not used as the output picture of the current picture.

Through the above-mentioned Implementation 1 and Implementation 2, the exemplary implementation process of which the decoding side determines whether to use the TIP frame corresponding to the current picture as the output picture of the current picture is introduced. It should be noted that, in addition to the methods shown in the above-mentioned Implementation 1 and Implementation 2 to determine whether to use the TIP frame corresponding to the current picture as the output picture of the current picture, the decoding side may further use other implementations to determine whether to use the TIP frame corresponding to the current picture as the output picture of the current picture, which is not limited in the embodiments of the present application.

After determining whether to use the TIP frame corresponding to the current picture as the output picture of the current picture based on the above method, the decoding side will perform following step of S102.

S102, in response to that it is determined that the TIP frame is used as the output picture of the current picture, decoding first information is skipped.

The first information is used to indicate a first interpolation filter, and the first interpolation filter is used to perform interpolation filtering on a reference block of a current block in the current picture.

In the embodiments of the present application, in response to that the decoding side determines that the TIP frame is used as the output picture of the current picture, the decoding process of the decoding side is to create the TIP frame corresponding to the current picture, and directly use the TIP as the output picture of the current picture, for example, outputting the TIP frame as the reconstructed picture of the current picture. The conventional decoding process of the current picture is skipped, that is, the step of determining the reference block of each decoded block in the current picture is skipped. The first interpolation filter is used to perform interpolation filtering on the reference block of the current block in the current picture, in a case where the step of determining the reference block of each decoded block in the current picture is skipped, there is no need to determine the first interpolation filter, and therefore decoding the first information indicating the first interpolation filter information is skipped, which may avoid decoding unnecessary information, and thus improving decoding performance.

In some embodiments, in a case where the decoding side determines that the TIP frame corresponding to the current picture is not used as the output picture of the current picture, as shown in FIG. 9, the method of the embodiments of the present application further includes the following steps.
S103, the first information is decoded.
S104, a first interpolation filter of the current block is determined based on the first information.
S105, the current block is decoded based on the first interpolation filter.

As shown in FIG. 9, in the embodiments of the present application, if the decoding side determines that the TIP frame is used as the output picture of the current picture based on the above steps, S102 is performed, to skip decoding the first information, thereby saving decoding time and improving decoding efficiency.

If the decoding side determines that the TIP frame is not used as the output picture of the current picture, S103 to S105 are performed, to achieve accurate decoding the current picture.

The exemplary implementation process of S103 to S105 will be introduced below.

In the embodiments of the present application, if the encoding side determines that the TIP frame is not used as the output picture of the current picture, for example, the current picture is not encoded using the TIP manner, or the current picture is encoded using the TIP manner and the corresponding TIP mode is TIP mode 1, in order to improve the accuracy of inter prediction, a reference block of the current block is determined in the reference frame of the current block, interpolation filtering is performed on the reference block of the current block, and based on the reference block after interpolation filtering, a prediction value of the current block is determined, thereby improving the accuracy of inter prediction. When performing interpolation filtering on the reference block of the current block, the first interpolation filter needs to be determined, and the first interpolation filter is used to perform interpolation filtering on the reference block of the current block. In this case, in order to maintain consistency between the encoding and decoding sides, the encoding side encodes the first information into the bitstream, to indicate first interpolation filter information corresponding to the current block.

Correspondingly, based on the above steps, if the decoding side determines that the TIP frame corresponding to the current picture is not used as the output picture of the current picture, the decoding side decodes the first information from the bitstream, determines the first interpolation filter corresponding to the current block based on the first information, and then decodes the current block based on the first interpolation filter. For example, the first interpolation filter is used to perform interpolation filtering on the reference block of the current block, to obtain the reference block after interpolation filtering; based on the reference block after interpolation filtering, the prediction value of the current block is determined, and based on the prediction value of the current block, the reconstructed value of the current block is determined.

The specific content included in the first information is not limited in the embodiments of the present application.

In some embodiments, the first information includes a first interpolation filter index corresponding to the current picture. In this way, the decoding side may determine, based on the first interpolation filter index, the first interpolation filter corresponding to the current picture from the interpolation filter list shown in Table 1.

In some embodiments, the first information includes a first flag, and the first flag is used to indicate whether an interpolation filter corresponding to the current picture is switchable, S104 includes the following steps.

S104-1, a first interpolation filter of the current block is determined based on the first flag.

In this embodiment, the encoding side determines whether the interpolation filter corresponding to the current picture is switchable, and indicates this information to the decoding side via the first flag, so that the decoding side determines the first interpolation filter of the current block based on the first flag.

In an example, in response to that the first flag indicates that the interpolation filter corresponding to the current picture is not switchable, the interpolation filter corresponding to the current picture is determined as the first interpolation filter of the current block.

Optionally, the interpolation filter corresponding to the current picture may be a default interpolation filter.

Optionally, the interpolation filter corresponding to the current picture is not the default interpolation filter. In this case, the encoding side determines the interpolation filter corresponding to the current picture from multiple interpolation filters, for example, an interpolation filter with the minimum cost among the multiple interpolation filters is determined as the interpolation filter corresponding to the current picture, then the determined interpolation filter index corresponding to the current picture is encoded (written) into the bitstream. In this way, the decoding side may obtain the interpolation filter index corresponding to the current picture by decoding the bitstream, and then determine the interpolation filter corresponding to the current picture.

In this example, in response to that it is determined that the first flag indicates that the interpolation filter corresponding to the current picture is not switchable, it means that first interpolation filters corresponding to the decoded blocks in the current picture are all the same, and are all interpolation filters corresponding to the current picture.

In another example, in response to that the first flag indicates that the interpolation filter corresponding to the current picture is switchable, the bitstream is decoded to obtain a first interpolation filter index; and the first interpolation filter is determined based on the first interpolation filter index.

In this example, in response to that the encoding side determines that the interpolation filter corresponding to the current picture is switchable, in a case of encoding the current block, the first interpolation filter corresponding to the current block is determined from multiple preset interpolation filters. For example, an interpolation filter with the minimum cost among the multiple interpolation filters is determined as the first interpolation filter corresponding to the current block, and the determined first interpolation filter index corresponding to the current block is written into the bitstream. In this way, the decoding side first obtains the first flag by decoding the bitstream. In response to that the first flag indicates that the interpolation filter corresponding to the current picture is switchable, the decoding side continues to decode the bitstream to obtain the first interpolation filter index, and based on the first interpolation filter index, an interpolation filter corresponding to the first interpolation filter index among the multiple preset interpolation filters is determined as the first interpolation filter.

That is, in this example, it may be understood that the first information includes the first flag and the first interpolation filter index corresponding to the current block.

The above describes the process of decoding the current picture in a case where the decoding side determines that the TIP frame corresponding to the current picture is not used as the output picture of the current picture.

The following compares the relevant syntax corresponding to the video decoding method proposed in the embodiments of the present application with the syntax of the prior art, to further illustrate the technical effect of the embodiments of the present application.

The relevant syntax of the prior art is shown in Table 8.

TABLE 8

| | Type |
|---|---|
| uncompressed_header( ) { | |
| ... | |
| if ( FrameIsIntra ) { | |
| ... | |
| } else { | |
| ... | |
| read_interpolation_filter( ) | |
| ... | |
| if(enable_tip) { | |
| tip_frame_mode | f(2) |
| ... | |
| } else { | |
| tip_frame_mode = TIP_FRAME_DISABLED | |
| } | |
| ... | |
| } | |
| ... | |
| } | |

The relevant syntax corresponding to the embodiments of the present application is shown in Table 9.

TABLE 9

| | Type |
|---|---|
| uncompressed_header( ) { | |
| ... | |
| if ( FrameIsIntra ) { | |
| ... | |
| } else { | |
| ... | |
| if (enable_tip) { | |
| tip_frame_mode | f(2) |
| ... | |
| } else { | |
| tip_frame_mode = TIP_FRAME_DISABLED | |
| } | |
| if (tip_frame_mode != TIP_FRAME_AS_OUTPUT) | |
| read_interpolation_filter( ) | |
| ... | |
| } | |
| ... | |
| } | |

It can be seen from Table 8 that, in the current technology, when decoding, the decoding side first obtains the first information by decoding, and then obtain relevant information of the TIP by decoding. However, it can be seen from the above that, if the current picture is encoded using the first TIP mode, there is no need to decode the first information. Therefore, there is redundancy in the syntax shown in Table 8, which not only wastes code words, but also wastes decoding resources, increases decoding time, and thus reducing decoding efficiency.

It can be seen from Table 9 that, in the embodiments of the present application, when decoding, the decoding side first determines whether the current picture is decoded using the TIP mode. In response to that the TIP manner is used for decoding, the TIP mode tip_frame_mode corresponding to the current picture is further decoded. Otherwise, it is determined that the current picture is not decoded using the TIP mode, that is, tip_frame_mode=TIP_FRAME_DISABLED. In some embodiments, the decoding side may determine whether to decode the first information based on the TIP mode corresponding to the current picture and whether the current picture is decoded using the TIP manner, the exemplary process refers to the description of the above embodiments. In some embodiments, in response to that the current picture is not encoded using the first TIP mode, in order to reduce decoding complexity, the indication is directly indicates via the second information by the encoding side, for example, the second information is that tip_frame_mode!=TIP_FRAME_AS_OUTPUT. In a case where the decoding side obtains the second information by decoding, the first information is decoded, i.e., read_interpolation_filter ( ) otherwise, decoding the first information is skipped, thereby saving decoding resources, reducing decoding time, so as to decoding efficiency is improved.

In some embodiments, in response to that the decoding side determines that the current picture is decoded using a TIP manner, a second interpolation filter corresponding to the current picture is determined, where the second interpolation filter is used to determine the TIP frame corresponding to the current picture. For example, the second interpolation filter is used to interpolate the forward reference frame Fi−1 and the backward reference frame Fi+1 of the current picture, to obtain the TIP frame corresponding to the current picture. The specific interpolation manner is not limited in the embodiments of the present application.

In a possible implementation, the decoding side determines the default interpolation filter as the second interpolation filter corresponding to the current picture.

Optionally, the second interpolation filter corresponding to the current picture is a MULTITAP_SHARP filter.

Optionally, the second interpolation filter corresponding to the current picture is a filter other than the MULTITAP_SHARP filter.

In another possible implementation, the bitstream is decoded to obtain a second flag, where the second flag is used to indicate a second interpolation filter index corresponding to the current picture; and the second interpolation filter is determined based on the second flag. In some implementation, the encoding side determines the second interpolation filter corresponding to the current picture from multiple interpolation filters, and encodes the second flag into the bitstream to indicate the second interpolation filter index corresponding to the current picture. In this way, the decoding side decodes the bitstream to obtain the second flag, and determines the second interpolation filter based on the second flag.

Optionally, the second interpolation filter corresponding to the current picture is an EIGHTTAP_REGULAR filter or an EIGHTTAP_SMOOTH filter.

In this embodiment, a method for determining the second interpolation filter corresponding to the current picture is introduced.

In some embodiments, since the TIP frame corresponding to the current picture is created in a unit of a picture block, in response to that the decoding side determines that the current picture is decoded using a TIP manner, a third interpolation filter corresponding to the picture block in the TIP frame is determined, where the third interpolation filter is used to determine the picture block in the TIP frame, and the third interpolation filter is used to interpolate to obtain the picture block in the TIP frame. That is to say, in this embodiment, the decoding side determines the third interpolation filter corresponding to each picture block in the TIP frame, and uses the third interpolation filter corresponding to each picture block to perform interpolation, to obtain each picture block in the TIP frame, and these picture blocks make up the TIP frame.

In an example of this embodiment, the decoding side determines the default filter as the third interpolation filter corresponding to each picture block in the TIP frame.

In another example of this embodiment, for each picture block in the TIP frame, the encoding side determines a third interpolation filter corresponding to the picture block from multiple interpolation filters, and encodes a third flag in the bitstream, where the third flag is used to indicate the third interpolation filter index corresponding to the picture block. In this way, the decoding side decodes the bitstream to obtain the third flag, and then determines the third interpolation filter corresponding to the picture block based on the third flag.

In some embodiments, the encoding side determines whether the interpolation filter corresponding to the TIP frame corresponding to the current picture is switchable, and indicates whether the interpolation filter corresponding to the TIP frame corresponding to the current picture is switchable via a fourth flag to the decoding side.

In an example, in response to that the fourth flag indicates that the interpolation filter corresponding to the TIP frame is not switchable, the second interpolation filter corresponding to the current picture is determined.

In an example, in response to that the fourth flag indicates that the interpolation filter corresponding to the TIP frame is switchable, the third interpolation filter corresponding to the current picture is determined.

In the video decoding method provided by the embodiments of the present application, when decoding the current picture, the decoding side first determines whether the current picture needs to use the TIP frame as the output picture of the current picture. In response to that it is determined that the TIP frame corresponding to the current picture needs to be used as the output picture of the current picture, decoding the first information corresponding to the current picture is skipped, where the first information is used to indicate the first interpolation filter, and the first interpolation filter is used to perform interpolation filtering on the reference block of the current block in the current picture. That is, in the present application, if it is determined that the TIP frame corresponding to the current picture is used as the output picture of the current picture, it means that other traditional decoding steps for the current picture are skipped, and the first interpolation filter is not needed to perform interpolation filtering on the reference block of the current block, thereby skipping decoding the first information, and avoiding decoding invalid information, and thus improving decoding performance.

The video decoding method provided by embodiments of the present application is described in detail above using the decoding side as an example, and the video encoding method provided by embodiments of the present application is described below using the encoding side as an example.

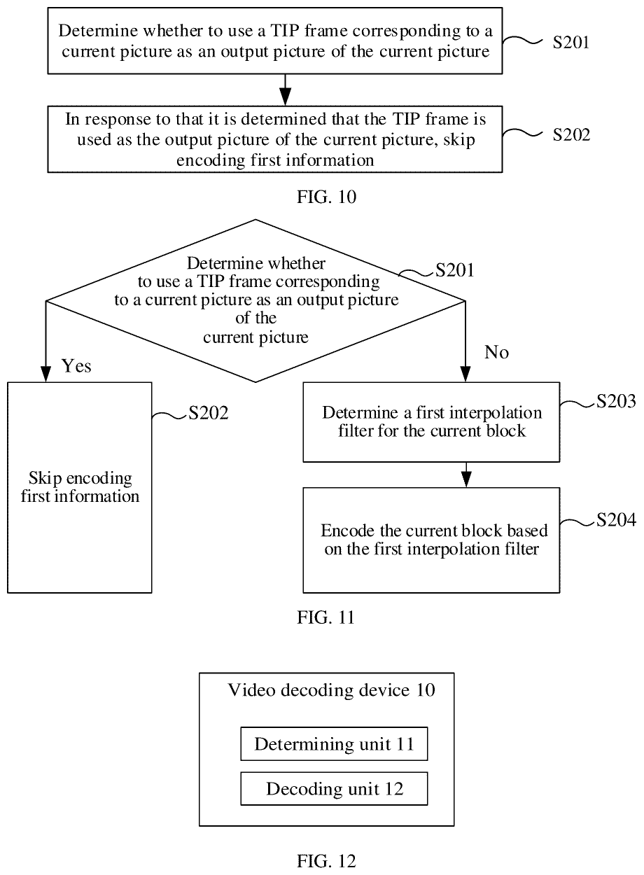

FIG. 10 is a schematic flowchart of a video encoding method provided by an embodiment of the present application. The video encoding method of the embodiments of the present application may be implemented by the video encoding device shown in FIG. 1 or FIG. 2.

As shown in FIG. 10, the video encoding method of the embodiments of the present application includes following content.

S201, whether to use a TIP frame corresponding to a current picture as an output picture of the current picture is determined.

It can be seen from the video encoding method that, in a case of encoding the current picture, for a current block in the current picture, a prediction value of the current block is determined by the inter prediction method or intra prediction method, the prediction value of the current block is subtracted from the current block to obtain a residual value of the current block, transform and quantization are performed on the residual value to obtain a quantization coefficient, the quantization coefficient is encoded to obtain a bitstream. In this case, inverse quantization is performed on the quantization coefficient of the current block to obtain a transform coefficient, and inverse transform is performed on the transform coefficient to obtain the residual value of the current block. And then, the prediction value of the current block is added to the residual value to obtain a reconstructed value of the current block.

In the embodiments of the present application, the current block may be understood as a picture block currently being encoded in the current picture. In some embodiments, the current block is also referred to as a current encoding block, a current picture block to be encoded, or the like.

The embodiments of the present application mainly relate to the inter prediction method, that is, the inter prediction method is used to determine the prediction value of the current block.

In some embodiments, in order to improve the accuracy of inter prediction, high accuracy motion compensation is used, that is, the inter prediction method is used to determine a reference block of the current block in a reference frame of the current block, perform interpolation filtering on the reference block of the current block, and based on the reference block after interpolation filtering, determine a prediction value or prediction block of the current block, to improve the prediction accuracy of the current block.

In some embodiments, in a case of encoding the current picture, the decoding side adopts the TIP technology, that is, a forward picture and a backward picture of the current picture are interpolated to obtain an intermediate interpolated frame. In the embodiments of the present application, the intermediate interpolated frame is denoted as a TIP frame, and the current picture is encoded based on the TIP frame.

Several possible cases for the embodiments of the present application will be described below.

Case 1: in the TIP technology, in some TIP modes, e.g., TIP mode 1 in shown Table 4, the current picture is encoded normally by using the TIP frame as an additional reference frame of the current picture. That is, if TIP mode 1 is used for the current picture, the encoding side first determines a reference frame list corresponding to the current picture, where the reference frame list includes N reference frames.

In this case, the encoding side takes the TIP frame as an additional reference frame of the current picture. Where the current picture includes N+1 reference frames. Based on the above method, after a new reference frame list is formed, the encoding side encodes the current picture based on the N+1 reference frames.

In some embodiments, in a case of encoding the current picture, the encoding side determines, for the current block in the current picture, a reference block corresponding to the current block in the N+1 reference frames, and determines a motion vector of the current block based on a position of the reference block in the reference frame and a position of the current block in the current picture. The motion vector may be understood as a prediction value, and the motion vector is encoded to obtain the bitstream. In this case, in the embodiment, the encoding side further indicates in the bitstream that the TIP technology is used for the current picture and TIP mode 1 in the TIP technology is used, for example, encoding an index of TIP mode 1 into the bitstream. In this way, in a case where the decoding side determines that the TIP technology is used for the current pictures and TIP mode 1 in the TIP technology is used by decoding the bitstream, the decoding side determines the TIP frame corresponding to the current picture, and takes the TIP frame as an additional reference frame of the current picture to decode the current picture. In some embodiments, if high accuracy motion compensation is used for the current picture, an inter prediction method is used to determine the reference block of the current block in the reference frame of the current block, and a first interpolation filter is used to perform interpolation filtering on the reference block of the current block, and based on the reference block after interpolation filtering, the prediction value or prediction block of the current block is determined.

In Case 1, it can be seen from the above that if the TIP technology is used for the current picture and TIP mode 1 in the TIP technology is used, that is, the TIP frame is used as an additional reference frame of the current picture for normal encoding the current picture, and in a case where sub-sample motion compensation is used for the current picture, it is necessary to use the first interpolation filter to perform interpolation filtering on the reference block of the current block.

Case 2: in the TIP technology, in some TIP modes, e.g., TIP mode 2 shown in Table 4, the TIP frame is used as the output picture of the current picture, and normal encoding of the current picture is skipped. That is, if TIP mode 2 is used for the current picture, the encoding side determines the TIP frame corresponding to the current picture, and directly stores the TIP frame in the decoding cache as the output picture of the current picture, that is, the TIP frame is directly taken as the reconstructed picture of the current picture. In this case, the encoding side indicates the TIP mode 2 to the decoding side, so that the decoding side skips decoding the current picture, for example, there is no need to determine the prediction value and residual value of each decoding block in the current picture, and perform inverse quantization and inverse transform on the residual value.

In Case 2, if the TIP technology is used for the current picture and the TIP mode 2 in the TIP technology is used, since the TIP frame is directly used as the output picture of the current picture, other encoding steps are skipped, and the step of determining the reference block of each encoding block in the current picture is also skipped, it can be determined that the encoding side does not need to use the first interpolation filter to perform interpolation filtering on the reference block of the current block.

Case 3: if the TIP technology is not used for the current picture, and sub-sample motion compensation is used for the current picture, the encoding side needs to determine the first interpolation filter and use the first interpolation filter to perform interpolation filtering on the reference block of the current block.

In Case 3, if the TIP technology is not used for the current picture and sub-sample motion compensation is used for the current picture, the reference block of the current block is determined, the first interpolation filter for the current block is determined, and the first interpolation filter is used to perform interpolation filtering on the reference block of the current block.

According to Case 1 to Case 3, it can be seen that determining whether to encode first information corresponding to the current picture (the first information is used to indicate the first interpolation filter) by the encoding side is related to whether to use the TIP frame corresponding to the current picture as the output picture of the current picture. Therefore, in the embodiments of the present application, before determining whether to encode the first information corresponding to the current picture, the encoding side first determines whether to use the TIP frame corresponding to the current picture as the output picture of the current picture.

In the embodiments of the present application, implementations of determining whether to use the TIP frame corresponding to the current picture as the output picture of the current picture include, but are not limited to the following implementations.

Implementation 1: in response to that it is determined that the current picture is not encoded using a TIP manner, it is determined that the TIP frame is not used as the output picture of the current picture.

In a case of encoding the current picture, the encoding side attempts various technologies and different encoding modes under the different technologies, and finally selects an encoding mode with the lowest cost to encode the current picture. If the encoding side determines that the current picture is not encoded using the TIP manner, it determines that the TIP frame is not used as the output picture of the current picture.

Implementation 2: S201 includes the following steps:
S201-A, in response to that it is determined that the current picture is encoded using a TIP manner, determining a TIP mode corresponding to the current picture; and
S201-B: determining whether to use the TIP frame as the output picture of the current picture based on the TIP mode corresponding to the current picture.

In some embodiments, the TIP mode corresponding to the current picture is a preset mode.

In some embodiments, determining the TIP mode corresponding to the current picture in S201-A above includes following steps S201-A1 to S201-A4.

S201-A1, the TIP frame is created.

Creating the TIP frame corresponding to the current picture will be introduced below.

The TIP frame corresponding to the current picture may be understood as an intermediate frame inserted between a forward reference frame and a backward reference frame of the current picture, and the intermediate frame is used to replace the current picture.

The method of inserting the intermediate frame between two frames is not limited in the embodiments of the present application.

In some embodiments, the creating process of the TIP frame includes three steps.

Step 1, a rough motion vector field of the TIP frame is obtained by modifying a projection of a temporal motion vector prediction (TMVP).

Exemplarily, first, the existing TMVP process is modified to support storing two motion vectors of blocks encoded using a compound mode. Furthermore, a generation order of the TMVP is modified to bias to the closest reference frame. This is done because the closer reference frame normally has higher motion correlation with the current picture.

The modified TMVP field will be projected to the two closest reference frames (i.e., the forward reference frame and the backward reference frame) to form the rough motion vector field of the TIP frame.

In Step 2, the rough motion vector field from step 1 is refined by filling holes and applying smoothing.

First, the motion vector field is refined. The rough motion vector field generated in step 1 may be too rough to obtain good quality when generating interpolated frames. In the embodiments of the present application, refinement processing is performed on the rough motion vector field, for example, hole filling smoothing is performed on the motion vector field, which helps in improving the quality of the final interpolated frame.

In an example, hole filling is performed on the rough motion vector field. In some implementation, after the motion vector is projected, some blocks may not have any relevant projected motion vector information, or may only have partial motion information related thereto. In this case, the block without any projected motion vector information or with only partial projected motion vector information is called a hole. Due to cover or not cover, the hole may appear, or may correspond to source blocks that are not associated with any motion vector in the reference coordinate system (e.g., in a case where the block is internal coded). To generate better interpolated frames, the hole may be filled with available projected motion vectors from neighboring blocks since they have higher correlation.

In another example, projected motion vector filtering is performed. In some implementation, the projected motion vector field may contain unnecessary discontinuities, which may cause artifacts and reduce the quality of the interpolated frame. A simple average filtering smoothing process is used to smooth the motion vector field. A motion vector of a block in a field may be smoothed using an average of motion vectors of the block itself and an average of motion vectors of its left/right/upper/lower adjacent blocks.

In Step 3, a TIP frame is generated using the refined motion vector field from step 2.

Based on the motion vector field refined in step 2, motion compensation is used to interpolate the two reference frames and the corresponding motion vectors in the field, to obtain the TIP frame. Optionally, when generating the final prediction, equal weights are used when combining the two reference frames.

S201-A2, a first cost when encoding the current picture is determined, in a case where the TIP frame is used as an additional reference frame of the current picture.

In some implementation, the first cost when encoding the current picture is determined in a second TIP mode. For example, the TIP frame is used as an additional reference frame of the current picture, to form the reference frame list as shown in Table 7. In the reference frame list, a reference frame with the minimum cost is determined, and based on the reference frame, the first cost when encoding the current picture is determined.

S201-A3, a second cost when the TIP frame is used as the output picture of the current picture is determined.

In some implementation, the second cost when encoding the current picture is determined in a first TIP mode, e.g., the second cost of which the TIP frame is used as the output picture of the current picture.

S201-A4, the TIP mode corresponding to the current picture is determined based on the first cost and the second cost.

For example, in response to that the first cost is greater than the second cost, it is determined that the TIP mode corresponding to the current picture is the first TIP mode, where the first TIP mode is a mode in which the TIP frame is used as the output picture of the current picture.

For another example, in response to that the first cost is less than the second cost, it is determined that the TIP mode corresponding to the current picture is the second TIP mode, where the second TIP mode is a mode in which the TIP frame is used as an additional reference frame of the current picture.

Based on the above steps, the TIP mode corresponding to the current picture is determined, and then S201-B is performed, to determine whether to use the TIP frame as the output picture of the current picture based on the TIP mode corresponding to the current picture.

The exemplary implementation of S201-B is not limited in the embodiments of the present application.

In a possible implementation, if the TIP mode corresponding to the current picture is the first TIP mode, it is determined that the TIP frame is used as the output picture of the current picture.

In another possible implementation, if the TIP mode corresponding to the current picture is not the first TIP mode, it is determined that the TIP frame is not used as the output picture of the current picture.

In some embodiments, the encoding side encodes the TIP mode corresponding to the current picture into the bitstream.

Implementation 3, in response to that it is determined that the current picture is not encoded using the first TIP mode, it is determined that the TIP frame is not used as the output picture of the current picture.

In Implementation 3, the encoding side encodes the second information into the bitstream, where the second information is used to indicate that a TIP mode corresponding to the current image is not the first TIP mode.

The first TIP mode of the embodiments of the present application may be understood as TIP mode 2 shown in Table 4, i.e., the mode of which the TIP frame corresponding to the current picture is used as the output picture of the current picture.

In Implementation 3, if the encoding side determines that the current picture is not encoded using the first TIP mode, for example, the current picture is not encoded using the TIP technology, or the current picture is encoded using the TIP technology but encoded using a non-first TIP mode in the TIP technology, e.g., encoded using TIP mode 1, the encoding side indicates the current picture being not encoded using the first TIP mode to the decoding side. Exemplarily, the encoding side encodes the second information in the bitstream, where the second information is used to indicate that the current picture is not encoded using the first TIP mode.

The specific form of the second information is not limited in the embodiments of the present application.

In some embodiments, the second information includes a flag A. If the encoding side determines that the current picture is not encoded using the first TIP mode, the flag A is set to true, e.g., set to 1. In this way, the decoding side may determine whether the current picture is encoded using the first TIP mode by decoding the flag A. If it is determined that the current picture is not encoded using the first TIP mode, for example, the flag A is equal to 1 (flag A=1), it is determined that the TIP frame is not used as the output picture of the current picture in the current picture.

In some embodiments, the second information includes an instruction, and the encoding side indicates that the current picture is not encoded using the first TIP mode via the instruction.

Exemplarily, the instruction included in the second information is that: tip_frame_mode!=TIP_FRAME_AS_OUTPUT. TIP_FRAME_AS_OUTPUT corresponds to the first TIP mode (i.e., TIP mode 2), as shown in Table 4, it indicates that the TIP frame is used as the output picture and there is no need to encode the current picture anymore.

In Implementation 3, the encoding side directly encodes the second information into the bitstream, and explicitly (directly) indicates that the current picture is not encoded using the first TIP mode via the second information. In this way, the decoding side may directly determine that the TIP frame is not used as the output picture of the current picture in the current picture via the second information, without having to make other reasoning judgments, thereby reducing the decoding complexity of the decoding side and improving the decoding performance.

In some embodiments, the encoding side encodes third information into the bitstream, where the third information is used to indicate whether the current picture is encoded using a TIP manner.

In this embodiment, the encoding side does not directly indicate that the encoding side does not use the first TIP mode to encode the current picture, that is, the encoding side does not directly indicate whether to use the TIP frame corresponding to the current picture as the output picture of the current picture. In this case, the decoding side needs to use other information to determine whether the current picture uses the TIP frame as the output picture of the current picture.

In some implementation, the encoding side encodes third information into the bitstream, and the third information is used to determine whether the current picture is encoded using the TIP manner. The decoding side determines, based on the third information, whether to use the TIP frame of the current picture as the output picture of the current picture when decoding the current picture.

The specific content and form of the third information are not limited in the embodiments of the present application.

In some embodiments, the third information includes a TIP enable flag, e.g., enable_tip, where the TIP enable flag is used to indicate whether the current picture is encoded using the TIP technology. In this way, the decoding side may determine whether the current picture is encoded using the TIP manner based on the TIP enable flag.

In an example, in response to that the encoding side determines that the current picture is encoded using the TIP manner, the TIP enable flag is set to true, e.g., set to 1. In this way, in a case where the decoding side determines that the TIP enable flag is true by decoding the bitstream, it is determined that the current picture is encoded using the TIP manner.

In another example, in response to that the encoding side determines that the current picture is not encoded using the TIP manner, the TIP enable flag is set to false, e.g., set to 0. In this way, in a case where the decoding side determines that the TIP enable flag is false by decoding the bitstream, it is determined that the current picture is not encoded using the TIP manner.

In some embodiments, the third information includes a first instruction, where the first instruction is used to indicate that TIP is disabled for the current picture. That is, in a case where it is determined that the current picture is not encoded using the TIP manner, the encoding side encodes the first instruction into the bitstream, and indicates that TIP is disabled for the current picture via the first instruction. In this way, the decoding side decodes the bitstream to obtain the first instruction, and determines, according to the first instruction, that the current picture is not encoded using the TIP manner.

The specific form of the first instruction is not limited in the embodiments of the present application.

In an example, the first instruction is tip_frame_mode=TIP_FRAME_DISABLED, it can be seen from Table 4, TIP_FRAME_DISABLED means disabling the TIP manner.

The foregoing are only examples of several manifestations of the third information. The manifestations and content included in the third information of the embodiments of the present application include, but are not limited to the foregoing examples.

Through the above-mentioned Implementation 1 and Implementation 2, the exemplary implementation process of which the encoding side determines whether to use the TIP frame corresponding to the current picture as the output picture of the current picture is introduced. It should be noted that, in addition to the methods shown in the above-mentioned Implementation 1 and Implementation 2 to determine whether to use the TIP frame corresponding to the current picture as the output picture of the current picture, the encoding side may further use other implementations to determine whether to use the TIP frame corresponding to the current picture as the output picture of the current picture, which is not limited in the embodiments of the present application.

After determining whether to use the TIP frame corresponding to the current picture as the output picture of the current picture based on the above method, the encoding side will perform following step S202.

S202, in response to that it is determined that the TIP frame is used as the output picture of the current picture, encoding first information is skipped.

The first information is used to indicate a first interpolation filter, and the first interpolation filter is used to perform interpolation filtering on a reference block of a current block in the current picture.

In the embodiments of the present application, in response to the encoding side determines that the TIP frame is used as the output picture of the current picture, the encoding process of the encoding side is to create the TIP frame corresponding to the current picture, and directly use the TIP as the output picture of the current picture, for example, the TIP frame is used as the reconstructed picture of the current picture. The conventional encoding process of the current picture is skipped, that is, the step of determining the reference block of each encoded block in the current picture is skipped. The first interpolation filter is used to perform interpolation filtering on the reference block of the current block in the current picture, in a case where the step of determining the reference block of each encoded block in the current picture is skipped, there is no need to determine the first interpolation filter, and therefore the encoding the first information indicating the first interpolation filter is skipped, which may avoid encoding unnecessary information, thereby saving code words, and saving encoding time, and thus improving encoding performance.

In some embodiments, in a case where the encoding side determines that the TIP frame corresponding to the current picture is not used as the output picture of the current picture, as shown in FIG. 11, the method of the embodiments of the present application further includes the following steps.
S203, a first interpolation filter of the current block is determined.
S204, the current block is encoded based on the first interpolation filter.

As shown in FIG. 11, in the embodiments of the present application, if the encoding side determines that the TIP frame is used as the output picture of the current picture based on the above steps, step S202 is performed, to skip encoding the first information, thereby saving encoding time and improving encoding efficiency.

If the encoding side determines that the TIP frame is not used as the output picture of the current picture, S203 to S204 are performed, to achieve accurate encoding of the current picture.

The exemplary implementation process of the above S203 to S204 will be introduced below.

In the embodiments of the present application, if the encoding side determines that the TIP frame is not used as the output picture of the current picture, for example, the current picture is not encoded using the TIP manner, or the current picture is encoded using the TIP manner and the corresponding TIP mode is TIP mode 1, in order to improve the accuracy of inter prediction, interpolation filtering is performed on the reference block of the current block. When performing interpolation filtering on the reference block, the first interpolation filter needs to be determined, and the first interpolation filter is used to perform interpolation filtering on the reference block.

The method of determining the first interpolation filter of the current block is not limited in the embodiments of the present application.

In some embodiments, the first interpolation filter of the current block is a preset filter.

In some embodiments, a first flag is determined, where the first flag is used to indicate whether an interpolation filter corresponding to the current picture is switchable, and then the first interpolation filter of the current block is determined based on the first flag.

In this embodiment, the encoding side determines the first flag, which may be preset, and determines whether the interpolation filter corresponding to the current picture is switchable via the first flag.

In an example, in response to that the first flag indicates that the interpolation filter corresponding to the current picture is not switchable, the interpolation filter corresponding to the current picture is determined as the first interpolation filter of the current block.

Optionally, the interpolation filter corresponding to the current picture may be a default interpolation filter.

Optionally, the interpolation filter corresponding to the current picture is not the default interpolation filter. In this case, the encoding side determines the interpolation filter corresponding to the current picture from multiple interpolation filters, for example, an interpolation filter with the minimum cost among multiple interpolation filters is determined as the interpolation filter corresponding to the current picture.

In this example, in response to that the first flag indicates that the interpolation filter corresponding to the current picture is not switchable, the interpolation filter corresponding to the current picture is determined as the first interpolation filter for the current block.

In another example, in response to that the first flag indicates that the interpolation filter corresponding to the current picture is switchable, the first interpolation filter of the current block is determined from multiple preset interpolation filters.

In this example, in response to that the encoding side determines that the interpolation filter corresponding to the current picture is switchable, in a case of encoding the current block, the first interpolation filter corresponding to the current block is determined from multiple preset interpolation filters. For example, an interpolation filter with the minimum cost among the multiple interpolation filters is determined as the first interpolation filter corresponding to the current block.

In some embodiments, after the encoding side determines the first interpolation filter of the current block based on the above method, in order to maintain consistency between the encoding and decoding sides, the encoding side encodes first information into the bitstream, to indicate first interpolation filter information corresponding to the current picture.

In some embodiments, in response to that the first flag indicates that the interpolation filter corresponding to the current picture is not switchable, the first information includes the first flag.

In some embodiments, in response to that the first flag indicates that the interpolation filter corresponding to the current picture is switchable, the first information includes the first flag and a first interpolation filter index.

That is, in this example, it may be understood that the first information includes the first flag and an index of the first interpolation filter corresponding to the current block.

In some embodiments, in response to that the encoding side determines that the current picture is encoded using a TIP manner, a second interpolation filter corresponding to the current picture is determined, where the second interpolation filter is used to determine the TIP frame corresponding to the current picture. For example, the second interpolation filter is used to interpolate the forward reference frame Fi−1 and the backward reference frame Fi+1 of the current picture, to obtain the TIP frame corresponding to the current picture. The specific interpolation manner is not limited in the embodiments of the present application.

In a possible implementation, the encoding side determines the default interpolation filter as the second interpolation filter corresponding to the current picture.

Optionally, the second interpolation filter corresponding to the current picture is a MULTITAP_SHARP filter.

Optionally, the second interpolation filter corresponding to the current picture is a filter other than the MULTITAP_SHARP filter.

In some embodiments, the encoding side determines the second interpolation filter corresponding to the current picture from multiple interpolation filters, and encodes a second flag into the bitstream, to indicate the second interpolation filter index corresponding to the current picture. In this way, the decoding side decodes the bitstream to obtain the second flag, and determines the second interpolation filter based on the second flag.

Optionally, the second interpolation filter corresponding to the current picture is an EIGHTTAP_REGULAR filter or an EIGHTTAP_SMOOTH filter.

In some embodiments, since the TIP frame corresponding to the current picture is created in a unit of a picture block, in response to that the encoding side determines that the current picture is encoded using a TIP manner, a third interpolation filter corresponding to the picture block in the TIP frame is determined, where the third interpolation filter is used to determine the picture block in the TIP frame, and the third interpolation filter is used to interpolate to obtain the picture block in the TIP frame. That is to say, in this embodiment, the encoding side determines the third interpolation filter corresponding to each picture block in the TIP frame, and uses the third interpolation filter corresponding to each picture block to perform interpolation, to obtain each picture block in the TIP frame, and these picture blocks make up the TIP frame.

In an example of this embodiment, the encoding side determines the default filter as the third interpolation filter corresponding to each picture block in the TIP frame.

In another example of this embodiment, for each picture block in the TIP frame, the encoding side determines a third interpolation filter corresponding to the picture block from multiple interpolation filters.

In some embodiments, the encoding side encodes a third flag in the bitstream, where the third flag is used to indicate a third interpolation filter index corresponding to the picture block. In this way, the decoding side decodes the bitstream to obtain the third flag, and then determines the third interpolation filter corresponding to the picture block based on the third flag.

In some embodiments, the encoding side determines a fourth flag, the fourth flag is used to indicate whether the interpolation filter corresponding to the TIP frame is switchable; and based on the fourth flag, determines whether the interpolation filter corresponding to the TIP frame is switchable.

In an example, in response to that the fourth flag indicates that the interpolation filter corresponding to the TIP frame is not switchable, the second interpolation filter corresponding to the current picture is determined.

In an example, in response to that the fourth flag indicates that the interpolation filter corresponding to the TIP frame is switchable, the third interpolation filter corresponding to the current picture is determined.

Optionally, the encoding side encodes the fourth flag into the bitstream, so that the decoding side determines whether the interpolation filter corresponding to the TIP frame is switchable via the fourth flag.

In the video encoding method provided by the embodiments of the present application, when encoding the current picture, the encoding side first determines whether the current picture needs to use the TIP frame as the output picture of the current picture. In response to that it is determined that the TIP frame corresponding to the current picture needs to be used as the output picture of the current picture, encoding the first information corresponding to the current picture is skipped, where the first information is used to indicate the first interpolation filter, and the first interpolation filter is used to perform interpolation filtering on the reference block of the current block in the current picture. That is, in the present application, if it is determined that the TIP frame corresponding to the current picture is used as the output picture of the current picture, it means that other traditional encoding steps s for the current picture are skipped, and the first interpolation filter is not needed to perform interpolation filtering on the reference block, thereby skipping encoding the first information, and avoiding encoding invalid information, and thus improving encoding performance.

It should be understood that FIGS. 6 to 9 are merely examples of the present application, which should not be construed as a limitation of the present application.

The exemplary embodiments of the present application are described in detail above in conjunction with the accompanying drawings, however, the present application is not limited in the specific details in the above embodiments. Within the technical concept of the present application, a variety of simple modifications can be made to the technical solution of the present application, and these simple modifications all fall within the protection scope of the present application. For example, the various specific technical features described in the above exemplary embodiments can be combined in any suitable manner without contradiction. In order to avoid unnecessary repetition, the present application will not further explain various possible combinations. For another example, the various implementations of the present application can be arbitrarily combined, and as long as they do not violate the concept of the present application, they should also be regarded as the content disclosed in the present application.

It should further be understood that, in the various method embodiments of the present application, the magnitude of serial numbers of the above-mentioned processes does not mean the order of execution. The execution order of each process should be determined by its function and internal logic, and should not constitute any limitation on the implementation process of the embodiments of the present application. In addition, in the embodiments of the present application, the term “and/or” is only an association relationship to describe associated objects, which means that there may be three kinds of relationships. In some implementation, A and/or B may indicate three cases that: A exists alone, both A and B exist, and B exists alone. In addition, a character “/” herein generally means that related objects before and after “/” are in an “or” relationship.

The method embodiments of the present application have been described in detail above with reference to FIGS. 8 to 11. The apparatus embodiments of the present application will be described in detail below with reference to FIGS. 12 to 15.

FIG. 12 is a schematic block diagram of a video decoding apparatus provided by the embodiments of the present application.

As shown in FIG. 12, a video decoding apparatus 10 may include:
a determining unit 11, configured to determine whether to use a temporal interpolated prediction (TIP) frame corresponding to a current picture as an output picture of the current picture; and
a decoding unit 12, configured to, in response to that it is determined that the TIP frame is used as the output picture of the current picture, skip decode first information, where the first information is used to indicate a first interpolation filter, and the first interpolation filter is used to perform interpolation filtering on a reference block of a current block in the current picture.

In some embodiments, the determining unit 11 is configured to decode second information corresponding to the current picture from a bitstream, where the second information is used to indicate that the current picture is not encoded using a first TIP mode, the first TIP mode is a mode in which the TIP frame is used as the output picture of the current picture; and determine that the TIP frame is not used as the output picture of the current picture based on the second information.

In some embodiments, the determining unit 11 is configured to decode third information from the bitstream, and the third information is used to determine whether the current picture is decoded using a TIP manner; determine whether to use the TIP frame as the output picture of the current picture based on the third information.

In some embodiments, the determining unit 11 is configured to, in response to that it is determined that the current picture is decoded using the TIP manner based on the third information, determine a TIP mode corresponding to the current picture; and determine whether to use the TIP frame as the output picture of the current picture based on the TIP mode corresponding to the current picture.

In some embodiments, the determining unit 11 is configured to, in response to that the TIP mode corresponding to the current picture is a first TIP mode, determine that the TIP frame is used as the output picture of the current picture, where the first TIP mode is a mode in which the TIP frame is used as the output picture of the current picture.

In some embodiments, the determining unit 11 is further configured to, in response to that the TIP mode corresponding to the current picture is a first TIP mode, create the TIP frame; and use the TIP frame as the output picture of the current picture and output the TIP frame.

In some embodiments, the determining unit 11 is configured to, in response to that the TIP mode corresponding to the current picture is not a first TIP mode, determine that the TIP frame is not used as the output picture of the current picture, where the first TIP mode is a mode in which the TIP frame is used as the output picture of the current picture.

In some embodiments, the determining unit 11 is further configured to, in response to that the TIP mode corresponding to the current picture is a second TIP mode, create the TIP frame, where the second TIP mode is a mode in which the TIP frame is used as an additional reference frame of the current picture; use the TIP frame as the additional reference frame of the current picture, and determine a reconstructed picture of the current picture.

In some embodiments, in a case where the third information includes a TIP enable flag, the determining unit 11 is further configured to determine whether the current picture is decoded using the TIP manner based on the TIP enable flag.

In some embodiments, the determining unit 11 is configured to, in response to that it is determined that the current picture is not decoded using the TIP manner based on the third information, determine that the TIP frame is not used as the output picture of the current picture.

In some embodiments, the determining unit 11 is further configured to, in response to that the third information includes a first instruction, determine that the current picture is not decoded using the TIP manner, where the first instruction is used to indicate that TIP is disabled for the current picture.

In some embodiments, the decoding unit 12 is further configured to, in response to that it is determined that the TIP frame is not used as the output picture of the current picture, decode the first information; determine a first interpolation filter of the current block based on the first information; and decode the current block based on the first interpolation filter.

In some embodiments, in a case where the first information includes a first flag, the decoding unit 12 is configured to, in response to that the first information includes the first flag, determine the first interpolation filter of the current block based on the first flag, where the first flag is used to indicate whether an interpolation filter corresponding to the current picture is switchable.

In some embodiments, the decoding unit 12 is configured to, in response to that the first flag indicates that the interpolation filter corresponding to the current picture is not switchable, determine the interpolation filter corresponding to the current picture as the first interpolation filter of the current block.

In some embodiments, the decoding unit 12 is configured to, in response to that the first flag indicates that the interpolation filter corresponding to the current picture is switchable, decode a bitstream to obtain a first interpolation filter index; and determine the first interpolation filter based on the first interpolation filter index.

In some embodiments, the decoding unit 12 is further configured to, in response to that it is determined that the current picture is decoded using a TIP manner, determine a second interpolation filter corresponding to the current picture, where the second interpolation filter is used to determine the TIP frame.

In some embodiments, the decoding unit 12 is further configured to decode a bitstream to obtain a second flag, where the second flag is used to indicate a second interpolation filter index corresponding to the current picture; and determine the second interpolation filter based on the second flag.

In some embodiments, the decoding unit 12 is further configured to, in response to that it is determined that the current picture is decoded using a TIP manner, determine a third interpolation filter corresponding to a picture block in the TIP frame, where the third interpolation filter is used to determine the picture block in the TIP frame.

In some embodiments, the decoding unit 12 is further configured to decode a bitstream to obtain a third flag, where the third flag is used to indicate a third interpolation filter index corresponding to the picture block; and determine the third interpolation filter corresponding to the picture block based on the third flag.

In some embodiments, the decoding unit 12 is further configured to, in response to that it is determined that the current picture is decoded using the TIP manner, decode a bitstream to obtain a fourth flag, where the fourth flag is used to indicate whether an interpolation filter corresponding to the TIP frame is switchable; and in response to that the fourth flag indicates that the interpolation filter corresponding to the TIP frame is not switchable, determine a second interpolation filter corresponding to the current picture, where the second interpolation filter is used to determine the TIP frame.

In some embodiments, the decoding unit 12 is further configured to, in response to that the fourth flag indicates that the interpolation filter corresponding to the TIP frame is switchable, determine a third interpolation filter corresponding to a picture block in the TIP frame, where the third interpolation filter is used to determine the picture block in the TIP frame.

It should be understood that, the apparatus embodiments and the method embodiments may correspond to each other, and similar descriptions may refer to the video decoding method embodiments, which will not be repeated here for the sake of brevity. In some implementation, the video encoding apparatus 10 shown in FIG. 12 may correspond to the corresponding subject performing the methods of the embodiments of the present application, and the aforementioned and other operations and/or functions of various units in the video encoding apparatus 10 are respectively for implementing the corresponding processes in the video decoding method, which will not be repeated here for the sake of brevity.

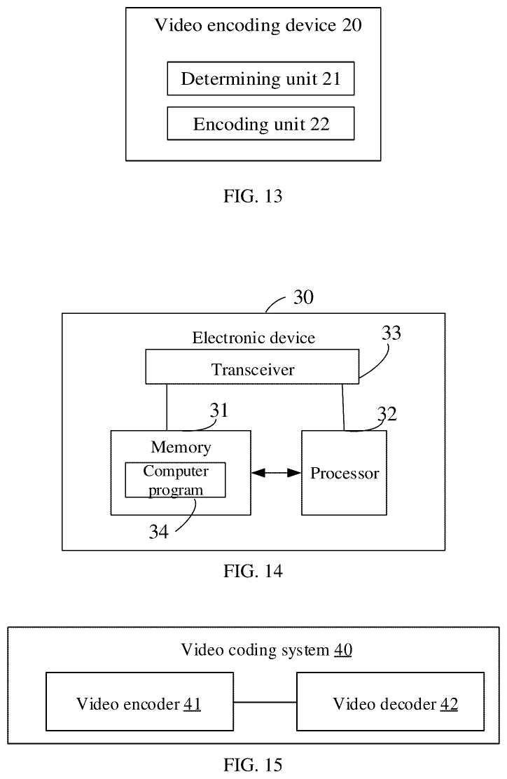

FIG. 13 is a schematic block diagram of a video encoding apparatus provided by the embodiments of the present application.

As shown in FIG. 13, the video encoding apparatus 20 includes:
a determining unit 21, configured to determine whether to use a temporal interpolated prediction (TIP) frame corresponding to a current picture as an output picture of the current picture; and
an encoding unit 22, configured to, in response to that it is determined that the TIP frame is used as the output picture of the current picture, skip encoding first information, where the first information is used to indicate a first interpolation filter, and the first interpolation filter is used to perform interpolation filtering on a reference block of a current block in the current picture.

In some embodiments, the determining unit 21 is configured to, in response to that it is determined that the current picture is not encoded using a TIP manner, determine that the TIP frame is not used as the output picture of the current picture.

In some embodiments, the determining unit 21 is configured to, in response to that it is determined that the current picture is encoded using a TIP manner, determine a TIP mode corresponding to the current picture; and determine whether to use the TIP frame as the output picture of the current picture based on the TIP mode corresponding to the current picture.

In some embodiments, the determining unit 21 is configured to, create the TIP frame; determine a first cost when encoding the current picture, in a case where the TIP frame is used as an additional reference frame of the current picture; determine a second cost when the TIP frame is used as the output picture of the current picture; and determine the TIP mode corresponding to the current picture based on the first cost and the second cost.

In some embodiments, the determining unit 21 is configured to, in response to that the first cost is greater than the second cost, determine that the TIP mode corresponding to the current picture is a first TIP mode, where the first TIP mode is a mode in which the TIP frame is used as the output picture of the current picture.

In some embodiments, the determining unit 21 is configured to, in response to that the first cost is less than the second cost, determine that the TIP mode corresponding to the current picture is a second TIP mode, where the second TIP mode is a mode in which the TIP frame is used as an additional reference frame of the current picture.

In some embodiments, the determining unit 21 is configured to, in response to that the TIP mode corresponding to the current picture is a first TIP mode, determine that the TIP frame is used as the output picture of the current picture, where the first TIP mode is a mode in which the TIP frame is used as the output picture of the current picture.

In some embodiments, the determining unit 21 is configured to, in response to that the TIP mode corresponding to the current picture is not a first TIP mode, determine that the TIP frame is not used as the output picture of the current picture, where the first TIP mode is a mode in which the TIP frame is used as the output picture of the current picture.

In some embodiments, the encoding unit 22 is further configured to encode the TIP mode corresponding to the current picture into a bitstream.

In some embodiments, the determining unit 21 is configured to, in response to that it is determined that the current picture is not encoded using a first TIP mode, determine that the TIP frame is not used as the output picture of the current picture, where the first TIP mode is a mode in which the TIP frame is used as the output picture of the current picture.

In some embodiments, the encoding unit 22 is further configured to encode second information into a bitstream, where the second information is used to indicate that a TIP mode corresponding to the current picture is not the first TIP mode.

In some embodiments, the encoding unit 22 is further configured to encode third information into the bitstream, where the third information is used to indicate whether the current picture is encoded using a TIP manner.

In some embodiments, the third information includes a TIP enable flag, and the TIP enable flag indicates whether the current picture is encoded using the TIP manner.

In some embodiments, in response to that the current picture is not encoded using the TIP manner, the third information includes a first instruction, where the first instruction is used to indicate that TIP is disabled for the current picture.

In some embodiments, the encoding unit 22 is further configured to, in response to that it is determined that the TIP frame is not used as the output picture of the current picture, determine the first interpolation filter corresponding to the current block; and encode the current block based on the first interpolation filter, where the first interpolation filter is used to determine a reference block in a reference frame for the current block in the current picture.

In some embodiments, the encoding unit 22 is configured to determine a first flag, where the first flag is used to indicate whether an interpolation filter corresponding to the current picture is switchable; and determine the first interpolation filter for the current block based on the first flag.

In some embodiments, the encoding unit 22 is configured to, in response to that the first flag indicates that the interpolation filter corresponding to the current picture is not switchable, determine the interpolation filter corresponding to the current picture as the first interpolation filter of the current block.

In some embodiments, the encoding unit 22 is configured to, in response to that the first flag indicates that the interpolation filter corresponding to the current picture is switchable, determine the first interpolation filter of the current block from multiple preset interpolation filters.

In some embodiments, the encoding unit 22 is further configured to determine the first information; and encode the first information into a bitstream, where the first information is used to indicate the first interpolation filter.

In some embodiments, in response to that a first flag indicates that an interpolation filter corresponding to the current picture is not switchable, the first information includes the first flag.

In some embodiments, in response to that a first flag indicates that an interpolation filter corresponding to the current picture is switchable, the first information includes the first flag and a first interpolation filter index.

In some embodiments, the encoding unit 22 is further configured to, in response to that it is determined that the current picture is encoded using a TIP manner, determine a second interpolation filter corresponding to the current picture, where the second interpolation filter is used to determine the TIP frame.

In some embodiments, the encoding unit 22 is further configured to encode a second flag into a bitstream, where the second flag is used to indicate a second interpolation filter index corresponding to the current picture.

In some embodiments, the encoding unit 22 is further configured to, in response to that it is determined that the current picture is encoded using a TIP manner, determine a third interpolation filter corresponding to a picture block in the TIP frame, where the third interpolation filter is used to determine the picture block in the TIP frame.

In some embodiments, the encoding unit 22 is further configured to encode a third flag into a bitstream, where the third flag is used to indicate a third interpolation filter index corresponding to the picture block.

In some embodiments, the encoding unit 22 is further configured to determine a fourth flag, where the fourth flag is used to indicate whether an interpolation filter corresponding to the TIP frame is switchable; and in response to that the fourth flag indicates that the interpolation filter corresponding to the TIP frame is not switchable, determine a second interpolation filter corresponding to the current picture, where the second interpolation filter is used to determine the TIP frame.

In some embodiments, the encoding unit 22 is further configured to, in response to that the fourth flag indicates that the interpolation filter corresponding to the TIP frame is switchable, determine a third interpolation filter corresponding to a picture block in the TIP frame, where the third interpolation filter is used to determine the picture block in the TIP frame.

In some embodiments, the encoding unit 22 is further configured to encode the fourth flag into a bitstream.

It should be understood that the apparatus embodiments and the method embodiments may correspond to each other, and similar descriptions may refer to the method embodiments, which will not be repeated here for the sake of brevity. In some implementation, the video encoding apparatus 20 shown in FIG. 13 may correspond to the corresponding subject performing the video encoding method of the embodiments of the present application, and the aforementioned and other operations and/or functions of various units in the video encoding apparatus 20 are respectively for implementing the corresponding processes in the video encoding method, which will not be repeated here for the sake of brevity.

The above describes the apparatus and system of the embodiments of the present application from the perspective of functional units in conjunction with the accompanying drawings. It should be understood that the functional units may be implemented in a hardware form, may be implemented by instructions in a software form, or may be implemented by a combination of hardware and software units. In some implementation, various steps of the method embodiments in the present application may be completed by an integrated logic circuit of hardware in the processor and/or instructions in the software form. The steps of the method disclosed in combination with the embodiments of the present application may be directly embodied as being performed and completed by a hardware decoding processor, or by using a combination of hardware and software units in the decoding processor. Optionally, the software unit may be located in the mature storage medium in the art, such as a random memory, a flash, a read-only memory, a programmable read-only memory, an electrically erasable programmable memory, or a register. The storage medium is located in a memory, and a processor reads information stored in the memory and completes the steps in the above method embodiments in combination with the hardware of the processor.

FIG. 14 is a schematic block diagram of an electronic device provided by the embodiments of the present application.

As shown in FIG. 14, the electronic device 30 may be a video decoding apparatus or a video encoding apparatus as described in the embodiments of the present application, and the electronic device 30 may include:

a memory 33 and a processor 32, where the memory 33 is configured to store a computer program 34 and transmit the computer program 34 to the processor 32. In other words, the processor 32 may call the computer program 34 from the memory 33 and run the computer program 34, to implement the methods in the embodiments of the present application.

For example, the processor 32 may be configured to perform the steps in the above method 200 according to instructions in the computer program 34.

In some embodiments of the present application, the processor 32 may include but is not limited to:

a general-purpose processor, a digital signal processor (DSP), an application specific integrated circuit (ASIC), a field programmable gate array (FPGA) or other programmable logic devices, a discrete gate or transistor logic device, a discrete hardware component.

In some embodiments of the present application, the memory 33 includes but is not limited to:

a volatile (transitory) memory and/or a non-volatile (non-transitory) memory. Herein, the non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash. The volatile memory may be a random access memory (RAM), which is used as an external cache. By way of illustrative rather than limiting illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM).

In some embodiments of the present application, the computer program 34 may be divided into one or more units, the one or more units are stored in the memory 33 and executed by the processor 32 to complete the methods provided by the present application. The one or more units may be a series of computer program instruction segments capable of completing specific functions, and the instruction segments are used to describe the execution process of the computer program 34 in the electronic device 30.

As shown in FIG. 14, the electronic device 30 may further include:

a transceiver 33, where the transceiver 33 may be connected to the processor 32 or the memory 33.

Here, the processor 32 may control the transceiver 33 to communicate with other devices, and for example, may transmit information or data to other devices, or receive information or data transmitted by other devices. The transceiver 33 may include a transmitter and a receiver. The transceiver 33 may further include an antenna(s), and the number of antenna(s) may be one or more.

It should be understood that the various components of the electronic device 30 are connected via a bus system, where the bus system includes not only a data bus, but also a power bus, a control bus and a status signal bus.

FIG. 15 is a schematic block diagram of a video coding system provided by the embodiments of the present application.

As shown in FIG. 15, the video coding system 40 may include: a video encoder 41 and a video decoder 42, where the video encoder 41 is configured to perform the video encoding method involved in the embodiments of the present application, and the video decoder 42 is configured to perform the video decoding method involved in the embodiments of the present application.

The present application further provides a bitstream, which is generated according to the above encoding method.

A non-transitory computer storage medium is further provided by the present application, and a computer program is stored on the non-transitory computer storage medium. The computer program, when executed by a computer, causes the computer to perform the method in the above method embodiments. In other words, a computer program product including instructions is further provided by the embodiments of the present application, and the instructions, when executed by a computer, cause the computer to perform the method in the above method embodiments.

When the above embodiments are implemented by using software, they may be implemented in the form of a computer program product in whole or in portion. The computer program product includes one or more computer instructions. When the computer program instructions are loaded and executed on a computer, processes or functions of the embodiments of the present application are generated in whole or in portion. The computer may be a general-purpose computer, a special-purpose computer, a computer network, or other programmable apparatus. The computer instructions may be stored in a non-transitory computer-readable storage medium, or transmitted from a non-transitory computer-readable storage medium to another non-transitory computer-readable storage medium. For example, the computer instructions may be transmitted from a website, computer, server, or data center to another website, computer, server, or data center via wired means (e.g., coaxial cable, fiber optic, digital subscriber line (DSL)) or wireless means (e.g., infrared, radio, microwave). The non-transitory computer-readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)) or a semiconductor medium (e.g., a solid state disk (SSD)), etc.

Those ordinary skilled in the art may realize that units and algorithm steps of the examples described in combination with the embodiments disclosed herein can be implemented in electronic hardware or in a combination of computer software and electronic hardware. Whether these functions are performed by hardware or software depends on an exemplary application and a design constraint of the technical solution. A skilled person may use different methods for each exemplary application, to implement the described functions, but such implementation should not be considered beyond the scope of the present application.

In the several embodiments provided in the application, it should be understood that, the disclosed systems, apparatus, and method may be implemented in other ways. For example, the apparatus embodiments described above are only schematic, for example, division of the units is only division with logical functions, and there may be other division methods in actual implementations, such as, a plurality of units or components may be combined or integrated into another system, or some features may be ignored or not performed. Furthermore, the coupling or direct coupling or communication connection between each other as shown or discussed may be indirect coupling or communication connection of apparatus or units via some interfaces, which may be electrical, mechanical, or in other forms.

The units described as separate components may be or may not be physically separated, and the components shown as units may be or may not be physical units, that is, they may be located in one place, or may be distributed onto a plurality of network units. All or a portion of the units may be selected according to actual needs, to implement the purpose of the schemes of the embodiments. For example, various functional units in the various embodiments of the present application may be integrated into one processing unit, or the various units may exist physically separately, or two or more units may be integrated into one unit.

The above contents are only exemplary implementations of the present application, but the protection scope of the present application is not limited thereto, and changes or substitutions, which may be easily thought by any skilled familiar with this technical field, within the technical scope disclosed in the present application should be all covered within the protection scope of the present application. Therefore, the protection scope of the present application should be subject to the protection scope of the claims.

What is claimed is:

1. A video decoding method, comprising:
determining whether to use a temporal interpolated prediction (TIP) frame corresponding to a current picture as an output picture of the current picture;
in response to that it is determined that the TIP frame is not used as the output picture of the current picture, decoding a first information, wherein the first information is used to indicate a first interpolation filter, and the first interpolation filter is used to perform interpolation filtering on a reference block of a current block in the current picture;
determining the first interpolation filter of the current block based on the first information; and
decoding the current block based on the first interpolation filter.

2. The method according to claim 1, wherein determining whether to use the temporal interpolated prediction (TIP) frame corresponding to the current picture as the output picture of the current picture comprises:
decoding second information corresponding to the current picture from a bitstream, wherein the second information is used to indicate that the current picture is not encoded using a first TIP mode, the first TIP mode is a mode in which the TIP frame is used as the output picture of the current picture; and
determining that the TIP frame is not used as the output picture of the current picture based on the second information.

3. The method according to claim 1, wherein determining whether to use the temporal interpolated prediction (TIP) frame corresponding to the current picture as the output picture of the current picture comprises:
decoding third information from a bitstream, wherein the third information is used to determine whether the current picture is decoded using a TIP manner; and
determining whether to use the TIP frame as the output picture of the current picture based on the third information.

4. The method according to claim 3, wherein determining whether to use the TIP frame as the output picture of the current picture based on the third information comprises:
in response to that it is determined that the current picture is decoded using the TIP manner based on the third information, determining a TIP mode corresponding to the current picture; and
determining whether to use the TIP frame as the output picture of the current picture based on the TIP mode corresponding to the current picture.

5. The method according to claim 4, wherein determining whether to use the TIP frame as the output picture of the current picture based on the TIP mode corresponding to the current picture comprises:
in response to that the TIP mode corresponding to the current picture is a first TIP mode, determining that the TIP frame is used as the output picture of the current picture, wherein the first TIP mode is a mode in which the TIP frame is used as the output picture of the current picture.

6. The method according to claim 4, wherein the method further comprises:
in response to that the TIP mode corresponding to the current picture is a first TIP mode, creating the TIP frame; and
using the TIP frame as the output picture of the current picture and outputting the TIP frame.

7. The method according to claim 4, wherein determining whether to use the TIP frame as the output picture of the current picture based on the TIP mode corresponding to the current picture comprises:
in response to that the TIP mode corresponding to the current picture is not a first TIP mode, determining that the TIP frame is not used as the output picture of the current picture, wherein the first TIP mode is a mode in which the TIP frame is used as the output picture of the current picture.

8. The method according to claim 7, wherein the method further comprises:
in response to that the TIP mode corresponding to the current picture is a second TIP mode, creating the TIP frame, wherein the second TIP mode is a mode in which the TIP frame is used as an additional reference frame of the current picture; and
using the TIP frame as the additional reference frame of the current picture, and determining a reconstructed picture of the current picture.

9. The method according to claim 1, wherein the method further comprises:
in response to that it is determined that the TIP frame is used as the output picture of the current picture, skipping decoding the first information.

10. A video encoding method, comprising:
determining whether to use a temporal interpolated prediction (TIP) frame corresponding to a current picture as an output picture of the current picture;
in response to that it is determined that the TIP frame is not used as the output picture of the current picture, determining a first interpolation filter corresponding to a current block; and
encoding the current block based on the first interpolation filter, wherein the first interpolation filter is used to perform interpolation filtering on a reference block of the current block in the current picture.

11. The method according to claim 10, wherein determining whether to use the temporal interpolated prediction (TIP) frame corresponding to the current picture as the output picture of the current picture comprises:
in response to that it is determined that the current picture is not encoded using a TIP manner, determining that the TIP frame is not used as the output picture of the current picture; and
in response to that it is determined that the current picture is encoded using the TIP manner, determining a TIP mode corresponding to the current picture; and
determining whether to use the TIP frame as the output picture of the current picture based on the TIP mode corresponding to the current picture.

12. The method according to claim 11, wherein determining the TIP mode corresponding to the current picture comprises:
creating the TIP frame;
determining a first cost when encoding the current picture, in a case where the TIP frame is used as an additional reference frame of the current picture;
determining a second cost when the TIP frame is used as the output picture of the current picture; and
determining the TIP mode corresponding to the current picture based on the first cost and the second cost.

13. The method according to claim 12, wherein determining the TIP mode corresponding to the current picture based on the first cost and the second cost comprises:
in response to that the first cost is greater than the second cost, determining that the TIP mode corresponding to the current picture is a first TIP mode, wherein the first TIP mode is a mode in which the TIP frame is used as the output picture of the current picture; and
in response to that the first cost is less than the second cost, determining that the TIP mode corresponding to the current picture is a second TIP mode, wherein the second TIP mode is a mode in which the TIP frame is used as an additional reference frame of the current picture.

14. The method according to claim 11, wherein determining whether to use the TIP frame as the output picture of the current picture based on the TIP mode corresponding to the current picture comprises:
in response to that the TIP mode corresponding to the current picture is a first TIP mode, determining that the TIP frame is used as the output picture of the current picture, wherein the first TIP mode is a mode in which the TIP frame is used as the output picture of the current picture; and
in response to that the TIP mode corresponding to the current picture is not a first TIP mode, determining that the TIP frame is not used as the output picture of the current picture, wherein the first TIP mode is a mode in which the TIP frame is used as the output picture of the current picture.

15. The method according to claim 11, wherein the method further comprises:
encoding the TIP mode corresponding to the current picture into a bitstream.

16. The method according to claim 10, wherein determining whether to use the temporal interpolated prediction (TIP) frame corresponding to the current picture as the output picture of the current picture comprises:
in response to that it is determined that the current picture is not encoded using a first TIP mode, determining that the TIP frame is not used as the output picture of the current picture, wherein the first TIP mode is a mode in which the TIP frame is used as the output picture of the current picture,
wherein the method further comprises:
encoding second information into a bitstream, wherein the second information is used to indicate that a TIP mode corresponding to the current picture is not the first TIP mode; and
encoding third information into a bitstream, wherein the third information is used to indicate whether the current picture is encoded using a TIP manner.

17. The method according to claim 10, wherein the method further comprises:
in response to that it is determined that the TIP frame is used as the output picture of the current picture, skipping encoding a first information, wherein the first information is used to indicate the first interpolation filter.

18. The method according to claim 17, wherein the method further comprises:
determining first information; and
encoding the first information into a bitstream, wherein the first information is used to indicate the first interpolation filter.

19. A video decoding apparatus, comprising a memory and a processor; wherein
the memory is configured to store a computer program; and
the processor is configured to call the computer program stored in the memory and run the computer program, to perform:
determining whether to use a temporal interpolated prediction (TIP) frame corresponding to a current picture as an output picture of the current picture;
in response to that it is determined that the TIP frame is not used as the output picture of the current picture, decoding a first information, wherein the first information is used to indicate a first interpolation filter, and the first interpolation filter is used to perform interpolation filtering on a reference block of a current block in the current picture;
determining the first interpolation filter of the current block based on the first information; and
decoding the current block based on the first interpolation filter.

20. A non-transitory computer-readable storage medium, having stored a bitstream generated according to the method according to claim 10.
